(19) United States
(12) Patent Application Publication
(10) Pub. No.: US 2015/0222959 A1
(43) Pub. Date: Aug. 6, 2015

(54) INFORMATION PROCESSING METHOD, AND INFORMATION PROCESSING SYSTEM

(71) Applicant: SHARP KABUSHIKI KAISHA, Osaka (JP)

(72) Inventors: Ryota HORII, Osaka (JP); Ikuo KESHI, Osaka (JP); Hiroyuki YAMAMURA, Osaka (JP); Toshiroh MUKAI, Osaka (JP); Takao INUI, Osaka (JP); Hideaki YAMADA, Osaka (JP)

(73) Assignee: SHARP KABUSHIKI KAISHA, Osaka (JP)

(21) Appl. No.: 14/606,561

(22) Filed: Jan. 27, 2015

(30) Foreign Application Priority Data
Jan. 31, 2014 (JP) 2014-016986

(51) Int. Cl. H04N 21/482; H04N 21/45; H04N 21/466; H04N 21/254; H04N 21/258

(52) U.S. Cl. CPC H04N 21/4828; H04N 21/254; H04N 21/25883; H04N 21/25891; H04N 21/4667; H04N 21/4532

(57) ABSTRACT

In one embodiment, an information processing method for an information processing apparatus includes, but is not limited to, the following processes. Viewing information indicating a state of television broadcast viewed by a viewer is acquired. Correspondence information indicating correspondence between a searching service that searches information in a prescribed field and the viewing information is acquiring from a storage unit included in the information processing apparatus. A searching service is selected based on the correspondence information acquired and the viewing information acquired. Selected service information indicating the searching service selected is outputted.

### BACKGROUND OF THE INVENTION

1. Field of the Invention

The present invention relates to an information processing method, and an information processing system.

Priority is claimed on Japanese Patent Application No. 2014-016986, filed Jan. 31, 2014, the content of which is incorporated herein by reference.

2. Description of the Related Art

In recent years, attempts have been made to apply information processing technology to add value to television broadcasts (for example, refer to Japanese Patent Application Publication No. 2003-331183). An example of developing information processing technology to television broadcasts that can be envisioned is providing a searching service. Also, because television viewing devices sometimes provide only simple input means, there is a desire to be able to use a searching service with a small amount of input.

### DISCLOSURE OF THE INVENTION

### Problems to be Solved by the Invention

Conventional art, however, is not necessarily able to provide a searching service suitable for a viewer of a television broadcast. In executing a search, in order to obtain more suitable search results, it is desirable to make an appropriate selection of a search service for searching information in a prescribed field. With conventional art, however, because it has not been possible to have the selected searching service reflect the type of viewer, there have been cases in which it has not been possible to provide a searching service suitable for the viewer.

The present invention has been made in consideration of the above-noted points, and provides an information processing apparatus, a terminal device, an information processing system, an information processing method, and a program capable of providing a searching service suitable for each television broadcast viewer.

### SUMMARY

In one embodiment, an information processing method for an information processing apparatus includes, but is not limited to, the following processes. Viewing information indicating a state of television broadcast viewed by a viewer is acquired. Correspondence information indicating correspondence between a searching service that searches information in a prescribed field and the viewing information is acquiring from a storage unit included in the information processing apparatus. A searching service is selected based on the correspondence information acquired and the viewing information acquired. Selected service information indicating the searching service selected is outputted.

In another embodiment, an information processing method for a terminal device configured to communicate with an information processing apparatus includes, but is not limited to, the following processes. A searching service indicated by selected service information output by the information processing apparatus is displayed. The searching service searches information in a prescribed field.

In another embodiment, an information processing system includes, but is not limited to, an information processing apparatus, and a terminal device. The information processing apparatus includes, but is not limited to, a viewing information acquisition unit, a selection unit, and an output unit. The viewing information acquisition unit is configured to acquire viewing information indicating the state of television broadcast viewed by a viewer. The selection unit is configured to acquire from a storage unit correspondence information indicating correspondence between a searching service that searches information in a prescribed field and the viewing information. The selection unit is configured to, based on the acquired correspondence information and the viewing information acquired by the viewing information acquisition unit, select the searching service. The output unit is configured to output selected service information indicating the searching service selected by the selection unit. The terminal device includes, but is not limited to, a display unit, and a display control unit. The display control unit is configured to cause the display unit to display the searching service indicated by the selected service information output by the information processing apparatus.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a drawing showing an example of an information processing system according to a first embodiment of the present invention.

FIG. 2 is a block diagram showing an example of the hardware constitution of an information processing system according to the first embodiment.

FIG. 3 is a block diagram showing an example of the functional constitution of a terminal device according to the first embodiment.

FIG. 4 is a block diagram showing an example of the functional constitution of an information processing apparatus according to the first embodiment.

FIG. 5 is a drawing showing an example of program information managed by a program information database according to the first embodiment.

FIG. 6 is a drawing showing an example of viewing information managed by a viewing history database according to the first embodiment.

FIG. 7 is a drawing showing an example of user information managed by a user information database according to the first embodiment.

FIG. 8 is a table showing an example of the correspondence between searching service information and priorities managed by a searching service information database according to the first embodiment.

FIG. 9 is a block diagram showing an example of the functional constitution of an analysis unit of an information processing apparatus according to the first embodiment.

FIG. 10 is a block diagram showing an example of the functional constitution of a searching service providing apparatus according to the first embodiment.

FIG. 11 is a flowchart showing an example of the flow of processing to select a searching service performed by the information processing apparatus according to the first embodiment.

FIG. 12 is a drawing showing a first example of the display mode made by a terminal device according to the first embodiment.

FIG. 13 is a drawing showing a second example of the display mode made by a terminal device according to the first embodiment.

FIG. 14 is a drawing showing a third example of the display mode made by a terminal device according to the first embodiment.

FIG. 15 is a drawing showing a fourth example of the display mode made by a terminal device according to the first embodiment.

FIG. 16 is a drawing showing a fifth example of the display mode made by a terminal device according to the first embodiment.

FIG. 17 is a table showing an example of the correspondence between searching service information and priorities managed by the searching service information database according to a second embodiment of the present invention.

FIG. 18 is a flowchart showing an example of the flow of processing performed by the information processing apparatus according to the second embodiment to select a searching service.

FIG. 19 is a block diagram showing an example of the functional constitution of the information processing apparatus according to a third embodiment of the present invention.

FIG. 20 is a flowchart showing an example of the flow of processing performed by the information processing apparatus according to the third embodiment to judge whether or not to output selected service information.

FIG. 21 is a flowchart showing an example of the flow of processing performed by the information processing apparatus according to a fourth embodiment of the present invention to judge whether or not to output selected service information.

FIG. 22 is a block diagram showing an example of the functional constitution of an information processing apparatus according to a fifth embodiment of the present invention.

FIG. 23 is a drawing showing an example of operation information managed by an operation history database according to the fifth embodiment.

FIG. 24 is a flowchart showing an example of the flow of processing performed by the information processing apparatus according to the fifth embodiment to judge whether or not to output selected service information.

FIG. 25 is a block diagram showing an example of the functional constitution of an information processing apparatus according to a sixth embodiment of the present invention.

FIG. 26 is a drawing showing a sixth example of the display mode made by a terminal device according to the sixth embodiment.

FIG. 27 is a drawing showing a seventh example of the display mode made by a terminal device according to the sixth embodiment.

FIG. 28 is a drawing showing an eighth example of the display mode made by a terminal device according to the sixth embodiment.

### DETAILED DESCRIPTION OF THE PREFERRED EMBODIMENTS

The present invention will now be described herein with reference to illustrative embodiments. The accompanying drawings explain an information processing apparatus, a terminal device, an information processing system, an information processing method, and a program in the embodiments. The size, the thickness, and the like of each illustrated portion might be different from those of each portion of an actual device.

Those skilled in the art will recognize that many alternative embodiments can be accomplished using the teachings of the present invention and that the present invention is not limited to the embodiments illustrated herein for explanatory purposes.

### First Embodiment

### System Constitution

The first embodiment of the present invention will be described below, with references made to the drawings.

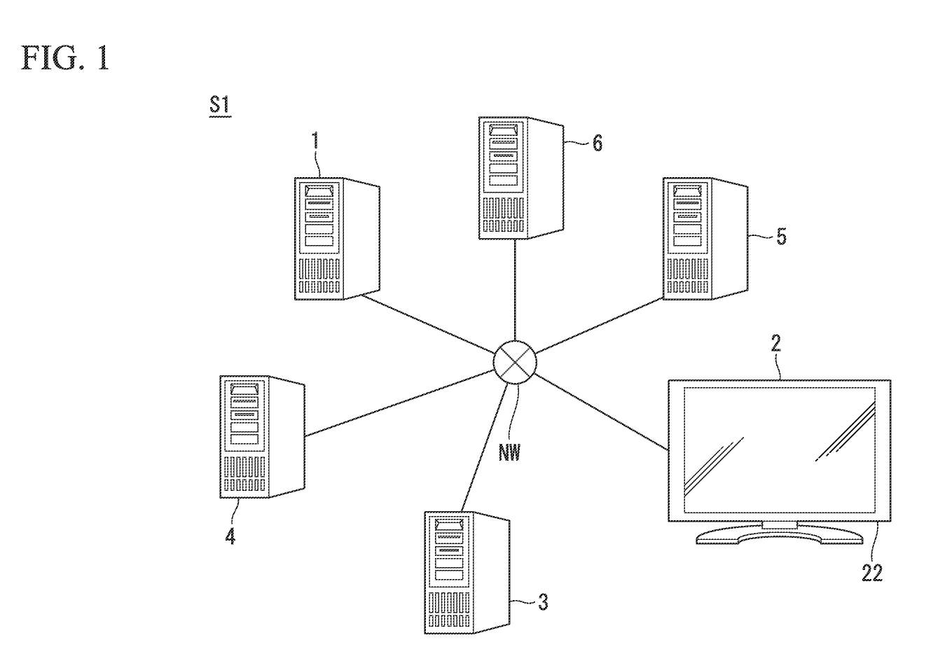

FIG. 1 shows an example of an information processing system S1 according to the first embodiment of the present invention.

The information processing system S1 of the present invention has an information processing apparatus 1, a terminal device 2, a program information providing apparatus 3, a viewing information server apparatus 4, a display template server apparatus 5, and a searching service providing apparatus 6.

The information processing apparatus 1, the program information providing apparatus 3, the viewing information server apparatus 4, the display template server apparatus 5, and the searching service providing apparatus 6 are, for example, server apparatuses having a known server function. The terminal device 2 is, for example, a television, a personal computer, a mobile telephone, a tablet, a smartphone, or a PDA (personal digital assistant). The information processing apparatus 1, the terminal device 2, the program information providing apparatus 3, the viewing information server apparatus 4, the display template server apparatus 5, and the searching service providing apparatus 6 are each connected to a network NW and can mutually communicate.

The network NW is an information communication network formed by, for example, a mobile telephone network, a PHS (Personal Handy-phone System) network, a VPN (virtual private network), a dedicated communication line network, a WAN (wide-area network), a LAN (local area network), or a PSTN (public switched telephone network), or a combination thereof.

The information processing apparatus 1 according to the present embodiment selects a service searching for information in a prescribed field. The terminal device 2 according to the present embodiment has a display unit 22 and displays a broadcast program of a television broadcast received by the display unit 22. The terminal device 2 also has a function of displaying a searching service selected by the information processing apparatus 1 and providing to a viewer an interface for using the searching service. In the following, the display of a broadcast program by the terminal device 2 is replaced by the watching of a broadcast program by a viewer using the terminal device 2. A person using the terminal device 2 and watching a broadcast program will be referred to as a viewer (user).

The program information providing apparatus 3 manages program information, this being an EPG (electronic program guide) and program metadata and transmits the program information to the information processing apparatus 1 and the terminal device 2. The electronic program guide includes information regarding, for example, broadcast channel, broadcast time, the name, the genre, the program content, and the main performers of a broadcast program. The metadata includes more detailed program content information than the electronic program guide, the performers, the broadcast times of segments making up the program, and keywords, and the like.

The viewing information server apparatus 4 stores the viewing history of a broadcast program indicating the state of the viewer watching the television program. For example, when the viewer switches the program being viewed, the viewing information server apparatus 4 transmits viewing information to the information processing apparatus 1 indicating the viewing history of the viewer. Therefore, the viewing history includes information of the program being watched by the viewer. The viewing information server apparatus 4 also stores an operation history regarding the state of searching service use by the viewer. If the viewer uses a searching service, the viewing information server apparatus 4 transmits to the information processing apparatus 1 operation information indicating the operation history. The display template server apparatus 5 stores screen layout templates displayed by the terminal device 2. The searching service providing apparatus 6 executes searching processing requested by the viewer via the terminal device 2.

### [Hardware Constitution]

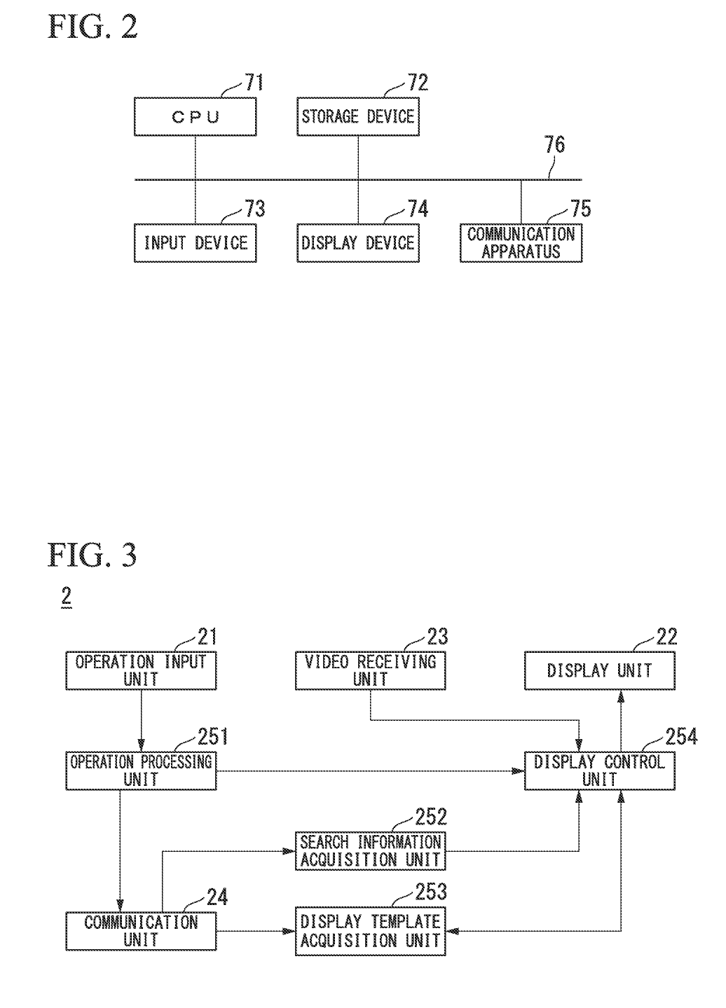

FIG. 2 is a block diagram showing an example of the hardware element constitution of the information processing apparatus 1, the terminal device 2, the program information providing apparatus 3, the viewing information server apparatus 4, the display template server apparatus 5, and the searching service providing apparatus 6.

The information processing apparatus 1, the terminal device 2, the program information providing apparatus 3, the viewing information server apparatus 4, the display template server apparatus 5, and the searching service providing apparatus 6 have a CPU (central processing unit) 71, a storage device 72, and an input device 73, a display device 74, and a communication apparatus 75. These elements are mutually connected, for example, via a bus 76 or a GPIO (general-purpose input/output). Omissions may be made of these elements, as appropriate, depending upon the form of each of the information processing apparatus 1, the terminal device 2, the program information providing apparatus 3, the viewing information server apparatus 4, the display template server apparatus 5, and the searching service providing apparatus 6. Also, the information processing apparatus 1, the terminal device 2, the program information providing apparatus 3, the viewing information server apparatus 4, the display template server apparatus 5, and the searching service providing apparatus 6 may have other elements that are not shown in the example.

The input device 73 is, for example, a remote controller, a mouse, a keyboard, or a touch panel.

The display device 74 is, for example, a liquid-crystal display or an organic EL (electroluminescence) display.

The communication apparatus 75 is, for example, a communication interface having an antenna or a network card, or a television tuner receiving a television broadcast.

### [Terminal Device Constitution]

Next, the various devices forming the information processing system S1 will be described.

The block diagram of FIG. 3 shows an example of the functional constitution of the terminal device 2.

The terminal device 2 has an operation input unit 21, a display unit 22, a video receiving unit 23, a communication unit 24, an operation processing unit 251, a search information acquisition unit 252, a display template acquisition unit 253, and a display control unit 254. The terminal device 2 has a generally known function of a television receiver and, as described above, has therewithin a CPU and a storage device.

The storage device, for example, has a HDD (hard disc drive), a flash memory, an EEPROM (electrically erasable programmable read-only memory), a ROM (read-only memory) or a RAM (random-access memory) and stores various programs for execution by the CPU of the terminal device 2 and the results of processing executed by the CPU. The operation processing unit 251, the search information acquisition unit 252, the display template acquisition unit 253, and the display control unit 254, for example, function by the execution by the CPU of the terminal device 2 of programs stored in the storage device.

The storage device stores user IDs and the type of terminal device 2. The user ID is information identifying a viewer, this being, for example, identification information assigned to the viewer by the administrator of the information processing apparatus 1. In this case, if the terminal device 2 is a TV or a personal computer, depending upon the make-up of a household, a plurality of viewers might use the same terminal device 2, in which case the plurality of viewers might share a user ID. Also, a single viewer might use a plurality of terminal devices 2, depending upon the situation, in which case, the viewer may use the same user ID with respect to the plurality of terminal devices 2. If the divided use of such terminal devices 2 is not considered, the user ID may be identification information unique to a terminal device 2, for example, a MAC (media access control) address.

The operation input unit 21 accepts from a viewer the input of operations regarding a broadcast program to be displayed on the terminal device 2 or operations with respect to a searching service. The operation input unit 21 has, for example, an input device such as a television remote controller, a mouse, a keyboard, or a touch panel. In the case of operating a searching service, for example, the content of the operation accepted by the operation input unit 21 is displayed by a GUI (graphical user interface) on a display device of the display unit 22.

The display unit 22 displays a broadcast program or searching service and has, for example, a liquid-crystal display or an organic EL (electroluminescence) display.

The video receiving unit 23 has a television tuner and receives a television broadcast.

The communication unit 24 has a communication interface and communicates with the information processing apparatus 1, the program information providing apparatus 3, the viewing information server apparatus 4, the display template server apparatus 5, and the searching service providing apparatus 6.

The operation processing unit 251 analyzes an operation accepted from the viewer by the operation input unit 21 and executes processing in response to the operation. The operation processing unit 251 accepts operations changing the viewing state, such as switching the power on or off and switching the channel, and transmits to the viewing information server apparatus 4 the change in the viewing state in accordance with the operation. For example, if the operation input unit 21 accepts input of a channel-switching operation, the operation processing unit 251 sends the channel information after switching to the communication unit 24, and information of the time of accepting the switching operation, the user ID, and the type of the terminal device 2 to the viewing information server apparatus 4, via the communication unit 24. The operation processing unit 251 outputs the channel information after switching to the display control unit 254.

For example, if the operation input unit 21 accepts a search request with respect to a searching service, the operation processing unit 251 transmits a search request including information indicating the searching service and the search words to the searching service providing apparatus 6, via the communication unit 24. The operation processing unit 251 transmits information indicating the searching service, search word information, the time the search request was accepted from the viewer, information of the type of the terminal device 2, and the user ID to the viewing information server apparatus 4. For example, if input of an operation that is accompanied by a change in the layout of the display screen, such as an operation with respect to a searching service that will be described later, is accepted by the operation input unit 21, the operation processing unit 251 notifies the display control unit 254 of an instruction to change the display screen layout.

The search information acquisition unit 252 acquires, via the communication unit 24, information of the search results transmitted from the searching service providing apparatus 6 in response to a search request transmitted by the operation processing unit 251. The search information acquisition unit 252 outputs information of the acquired search results to the display control unit 254.

The display template acquisition unit 253 acquires display template information indicating a display screen layout form the display template server apparatus 5 and outputs the acquired display template information to the display control unit 254.

The display control unit 254, in accordance with the screen layout indicated by display template information acquired from the display template acquisition unit 253, generates a display image in which the broadcast program of the television broadcast received by the video receiving unit 23, the searching service interface, search results, and the like are placed on the screen. If an instruction to change the display screen layout is acquired from the operation processing unit 251, the display control unit 254 acquires the display screen layout via the display template acquisition unit 253 and causes display of the generated display screen on the display unit 22. The display template information shows, for example, the screen region for display of the television broadcast program and the screen region for display of the search results. In this manner, the display control unit 254 controls the display on the display unit 22, based on the display template, so as to display a plurality of screens simultaneously.

### [Information Processing Apparatus Constitution]

Next, the constitution of the information processing apparatus 1 will be described.

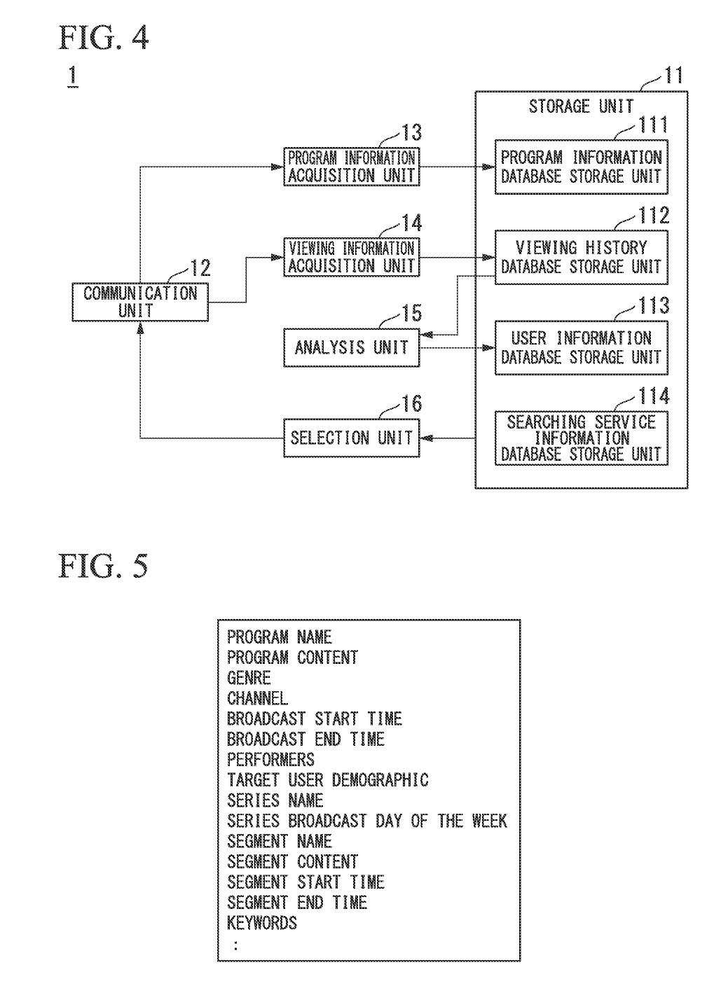

The block diagram of FIG. 4 shows an example of the functional constitution of the information processing apparatus 1.

The information processing apparatus 1 has a storage unit 11, a communication unit 12, a program information acquisition unit 13, a viewing information acquisition unit 14, an analysis unit 15, and a selection unit 16. The information processing apparatus 1, as described above, has therewithin a CPU and storage device.

The storage unit 11, for example, has a HDD (hard disc drive), a flash memory, an EEPROM (electrically erasable programmable read-only memory), a ROM (read-only memory) or a RAM (random-access memory) and stores firmware, application programs, such as various programs for execution by the CPU of the information processing apparatus 1, and the results of processing executed by the CPU. The program information acquisition unit 13, the viewing information acquisition unit 14, the analysis unit 15, and the selection unit 16, for example, function by the execution by the CPU of the information processing apparatus 1 of programs stored in the storage unit 11.

The storage unit 11 has a program information database storage unit 111, a viewing history database storage unit 112, a user information database storage unit 113, and a searching service information database storage unit 114.

The program information database storage unit 111 stores a program information database that manages program information.

FIG. 5 shows an example of the program information managed by the program information database.

The program information managed by the program information database has the items “Program name”, “Program content”, “Genre”, “Channel”, “Broadcast start time”, “Broadcast end time”, “Performers”, “Target user demographic”, “Series name”, “Series broadcast day of the week”, “Segment name”, “Segment content”, “Segment start time”, “Segment end time”, and “Keywords”.

The “Program name” is the name of the program. The “Program content” indicates the content of the program and is, for example, a summary of the program content. “Genre” is the classification of the program based on its content. “Genre” is, for example, news, general talk program, animation, sports, variety, drama, cooking, or travel. “Genre” may be indicated hierarchically. For example, the lower-level genres of soccer, baseball, or basketball may be associated with the upper-level genre of sports. Also, a plurality of the above-noted items may be recorded in one record of program information.

“Channel” indicates the channel used at the time of broadcast of the program, this being established, for example, individually for each station broadcasting the program. “Broadcast start time” indicates the starting time of the broadcast of the program as, for example, the values of year, month, day, and time. “Broadcast end time” indicates the ending time of the broadcast of the program as, for example, the values of year, month, day, and time. “Performers” indicates the names of performers appearing in the program. “Target user demographic” indicates the expected main viewer demographic as the user targeted by the program. The user demographic will be described in detail later in the description of the user information. “Series name” indicates the name of a series when the program is part of a series, this being, for example, the name of a drama program broadcast at a prescribed time on a prescribed day of each week. “Series broadcast day of the week” indicates the day of the week that a program as part of a series is broadcast.

“Segment name” indicates the name of a segment forming a part of a program. “Segment content” indicates the content of a segment. “Segment start time” indicates the starting time of the broadcast of the segment as, for example, the values of year, month, day, and time. “Segment end time” indicates the ending time of the broadcast of the segment as, for example, the values of year, month, day, and time. “Keywords” indicates words and phrases characteristic of the content of the program. The “Segment name”, “Segment content”, “Segment start time”, “Segment end time”, and “Keywords” items may, for example, exist multiply in one record of program information.

The viewing history database storage unit 112 stores a viewing history database that manages viewing information.

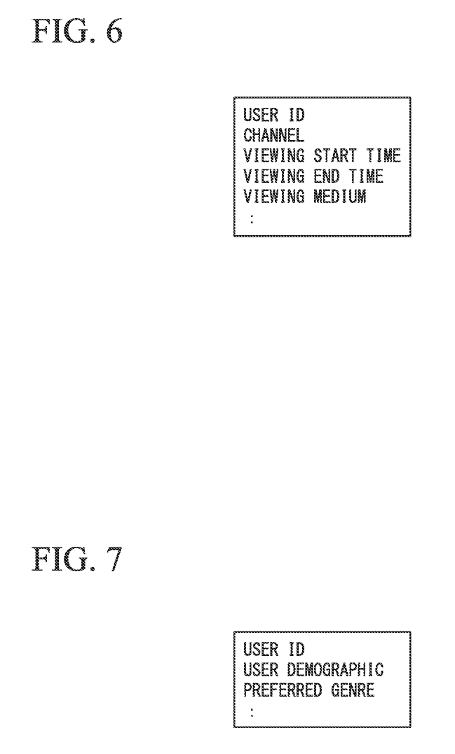

FIG. 6 shows an example of the viewing information managed by the viewing history database.

The viewing information managed by the viewing history database has the items “User ID”, “Channel”, “Viewing start time”, and “Viewing end time”. The “User ID” is the user ID stored by the terminal device 2.

“Channel” is the same as the “Channel” in the program information. “Viewing start time” indicates the starting time of the viewer watching the program as, for example, the values of year, month, day, and time. “Viewing end time” indicates the ending time of the viewer watching the program as, for example the values of year, month, day, and time. In this manner, because the viewing information includes “Channel”, “Viewing start time”, and “Viewing end time”, by referencing the “Channel”, “Viewing start time”, and “Viewing end time”, it is possible to obtain information about a viewed program. “Viewing medium” indicates the type of the terminal device 2, which is an item such as television, personal computer, mobile telephone, tablet, smartphone, or PDA.

The user information database storage unit 113 stores a user information database that manages user information indicating viewer attributes.

FIG. 7 shows an example of user information managed by the user information database. The user information managed by the user information database has the items “User ID”, “User demographic”, and “Preferred genre”. “User ID” is the same as “User ID” in the viewing information.

“User demographic” indicates a group classification of a viewer based on a prescribed index, such as the age, gender, and lifestyle of the viewer. Lifestyle is information related to the television program viewing habits and includes such information as whether or not the viewer is employed and, if employed, it includes information regarding holidays and working hours. If the viewer is not employed, the information includes whether the viewer is a housewife, whether the viewer is a student, and information regarding the hours of activity of the viewer.

“Preferred genre” is one characteristic of the viewer, and is the genre of programs that the viewer prefers to watch. “Preferred genre” indicates one or a plurality of the items given as examples in the description of “Genre” in the program information. If a plurality of users share a user ID, “User demographic” and “Preferred genre” may be associated individually with each of the plurality of viewers.

The searching service information database storage unit 114 stores a user information database that manages searching service information and the priorities thereof.

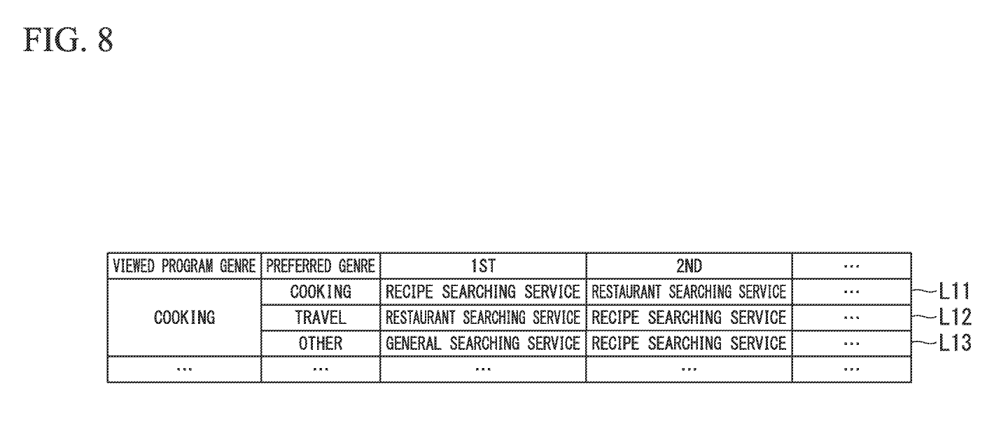

The table of FIG. 8 shows an example of the searching service information and associated priorities managed by the searching service information database.

The records managed by the searching service information database have the items “Viewed program genre”, “Preferred genre”, and the searching service information of each priority (1st, 2nd, . . . ). “Viewed program genre” indicates the genre of a program being watched by the viewer, and “Preferred genre” indicates the genre preferred by the viewer. “Viewed program genre” and “Preferred genre” indicate any of the items given as examples in the description of “Genre” in the program information, or “Other”. “1st” indicates that the searching service has the first priority, and “2nd” indicates that the searching service has the second priority.

In this manner, the searching service information database storage unit 114 stores correspondence information (first correspondence information and third correspondence information) associating viewer attributes analyzed based on viewing information with searching services. In the analysis of viewer attributes, which will be described later, because the association between viewer attributes and searching services is used, it can be said that the correspondence information associate the viewing information with the searching services. The correspondence information may be a function rather than a table.

Viewer attributes is a concept encompassing viewer characteristics and grouping (classifications and categories), and is information obtained individually from the viewing history of each viewer.

Returning to FIG. 4, the program information acquisition unit 13 acquires program information from the program information providing apparatus 3, via the communication unit 12 and registers the acquired program information into the program information database.

The viewing information acquisition unit 14 acquires viewing information from the viewing information server apparatus 4, via the communication unit 12, and registers the acquired viewing information into the viewing history database.

The analysis unit 15 acquires viewing information of the viewer-under-analysis from the viewing history database and, based on the viewing history indicated by the viewing information, analyzes the user demographic and preferred genre as attributes of the viewer. The analysis unit 15, for example, executes processing periodically. The details of the processing performed by the analysis unit 15 will be described later. The analysis unit 15 associates the analyzed user demographic and preferred genre with the user ID of the viewer-under-analysis and registered these into the user information database.

The selection unit 16 selects a searching service, based on the correspondence information in the searching service information database and on the viewer attributes analyzed by the analysis unit 15. The selection unit 16 acquires the genre of the programs watched by the viewer who will be provided the searching service by referencing the viewing history database and the program information database. The selection unit 16 acquires the preferred genre of the viewer from the user information database. The selection unit 16, based on the acquired viewed program genre and preferred genre, selects a searching service from the searching service information database in association with a priority. The selection unit 16 transmits selected service information indicating the selected searching service to the terminal device 2, via the communication unit 12. In this manner, the communication unit 12 outputs selected service information indicating the searching service selected by the selection unit 16.

Next, the processing by the analysis unit 15 will be described in detail.

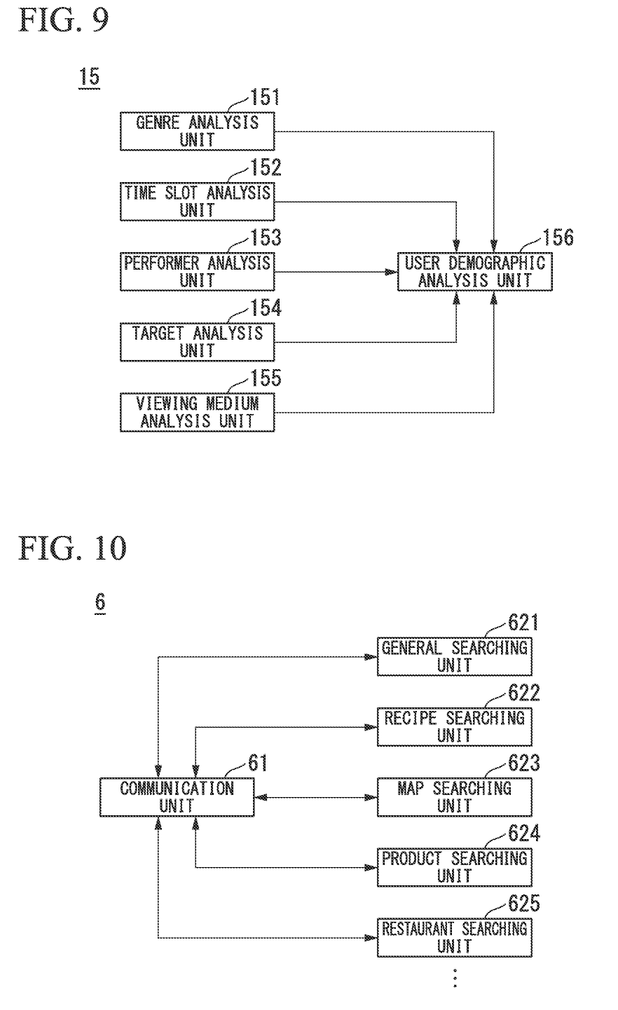

The block diagram of FIG. 9 shows an example of the functional constitution of the analysis unit 15 of the information processing apparatus 1.

The analysis unit 15 has a genre analysis unit 151, a time slot analysis unit 152, a performer analysis unit 153, a target analysis unit 154, a viewing medium analysis unit 155, and a user demographic analysis unit 156.

The genre analysis unit 151 analyzes the user demographic and the preferred genre, based on the genre of the viewing history. For example, the genre analysis unit 151 totals and compares the number of viewed programs of each genre over a prescribed time period of, for example, one month or six months. The genre analysis unit 151, as a result of the comparison, for example, judges a genre having a number of viewed programs with respect to the overall number of programs exceeding a prescribed threshold to be the preferred genre. Also, for example, the genre analysis unit 151 judges a genre having a number of viewings that exceeds a prescribed threshold to be the preferred genre.

The genre analysis unit 151, for example, totals and compares the viewing time over a prescribed time period for each genre and, as a result of the comparison, judges the genre having a ratio of viewing time with respect to the total viewing time that exceeds a prescribed time threshold to be the preferred genre. Also, for example, the genre analysis unit 151 judges a genre having a viewing time exceeding a prescribed threshold time to be the preferred genre. The genre analysis unit 151 outputs information indicating the judged preferred genre and information of the viewing times for each genre to the user demographic analysis unit 156 and registers information indicating the judged preferred genre in association with the user ID of the viewer-under-analysis into the user information database.

The time slot analysis unit 152 analyzes the viewing history regarding viewing time slots. The time slot analysis unit 152, for example, analyzes the change in viewing times in accordance with the day of the week and time slot of the viewing time. The time slot analysis unit 152, for example, calculates the total viewing time over one day for each day of the week and outputs information indicating the calculated total viewing time for each day of the week to the user demographic analysis unit 156. The time slot analysis unit 152, for example, totals the viewing time over one week for each time slot and outputs information indicating the total viewing time for each time slot to the user demographic analysis unit 156.

The performer analysis unit 153 analyzes the viewing history regarding performers. For example, the performer analysis unit 153 calculates the number of viewed programs for each performer over a prescribed period of time such as one month or six months and outputs information of the calculated number of viewed programs for each performer to the user demographic analysis unit 156.

The target analysis unit 154 analyzes the viewing history regarding the target user demographic. The target analysis unit 154, for example, calculates the number of viewed programs for each target user demographic over a prescribed period of time, such as one month or six months and outputs information of the calculated number of viewed programs for each target user demographic to the user demographic analysis unit 156.

The viewing medium analysis unit 155 analyzes the viewing history regarding the viewing media. The viewing medium analysis unit 155, for example, in the same viewing time slot calculates the maximum number of viewing media used and outputs information of the calculated maximum number of viewing media to the user demographic analysis unit 156. The viewing medium analysis unit 155, for example, totals the viewing time in each time slot over a prescribed period of time for each viewing medium. The viewing medium analysis unit 155 outputs information of the totaled viewing time for each viewing medium to the user demographic analysis unit 156.

The user demographic analysis unit 156, based on the various information acquired from the time slot analysis unit 152, the performer analysis unit 153, the target analysis unit 154, and the viewing medium analysis 155, estimates the user demographic of the viewer, examples of the user demographic estimation by the user demographic analysis unit 156 being given below.

For example, if the viewing time is long on a specific day of the week, it is estimated that that viewer is a worker or student having off the day of the week with a long viewing time. In contrast, if the viewing time is long regardless of the day of the week, it is estimated that there are a plurality of viewers, such as couples, with different viewing time slots or that there are viewers who are non-workers, such as housewives or elderly persons. Also, for example, if the early-morning viewing time is long and the evening viewing time is short, it is estimated that the viewers are elderly or workers who work at an early in the day. If the midday viewing time is long, it is estimated that there are housewives or children or elderly persons among the viewers.

For example, if there is a large number of views of programs with a specific performer, the user demographic can be estimated from the performer. The popularity of a performer sometimes varies greatly depending upon the generation of the viewer. For example, if there are a large number of viewed programs for a young male idol, the viewer is estimated to be a young female.

For example, if there is a large number of views of programs regarding a specific target user demographic, it is estimated that the viewers are matched to the user demographic indicated by the target user demographic. For example, if the number of views of a program targeted at male users in their twenties is large, it is estimated that the viewers are males in their twenties.

For example, in the case of the preferred genre being animation or education for young children, it is estimated that pre-school children are the viewers. Also, for example, if the preferred genre is economics news, it is estimated that that businessmen are the viewers.

For example, if a plurality of viewing media are being used in the same time slot, it is estimated that there are a plurality of viewers.

The user demographic analysis 156 estimates the user demographic by combining the analysis of the viewing history regarding time slots, performers, target user demographic, and viewing medium.

For example, if it is estimated that viewers include females in their twenties or thirties, and there is viewing time for program the genre of which is animation or special effects on Saturday of Sunday mornings, it is estimated that housewives and pre-school children are the viewers. Also, for example on a weekday, if the viewing times in the morning and evening time slots are long and there are a large number of viewed programs the target user demographic of which are either male or female, it is estimated that viewers are working couples. Also, for example, if the viewing times with smartphones as the viewing medium are long in the morning, it is estimated that viewers are businessmen who view TV on smartphones while commuting.

The user demographic analysis unit 156, for example, judges each of these estimation conditions and, if the judged condition is matched, a number of points is added to each estimated user demographic, in accordance with the certainty thereof. Also, if the judgment condition is not matched, for example, a number of points are subtracted from each estimated user demographic, in accordance with the certainty thereof. The user demographic analysis unit 156, for the viewer age, gender, and lifestyle, selects items for which the number of points for each user demographic exceeds a prescribed threshold. Information indicating the correspondence between user attributes used in these judgments and the viewing information may be, for example, stored as a second correspondence information in the storage unit 11.

For example, if the items for the age groups of under-10, teens, 20s, 30s, 40s, 50s and 60 or over are established, the user demographic analysis unit 156 selects from among these the age groups having a number of points exceeding a prescribed threshold. Also, for example, if the items for age groups of child, adult, and elderly are established, the user demographic analysis unit 156 selects from among these the age groups having a number of points exceeding a prescribed threshold. Also, for example, if the items for gender of male and female are established, the user demographic analysis unit 156 selects from among male and female the gender or genders having a number of points exceeding a prescribed threshold. Also, for example, if the items for lifestyle of employed and non-employed are established, the user demographic analysis unit 156 selects from among employed and non-employed the lifestyle or lifestyles having a number of points exceeding a prescribed threshold.

If there is mutual conflict between selected items, the user demographic analysis unit 156 estimates the existence of a plurality of viewers. For example, with regard to gender, if both male and female items are above a prescribed threshold, the estimation is made that there are at least two viewers including a male and a female. The user demographic analysis unit 156 then, of the items for which the prescribed threshold is exceeded, assigns the item that has a higher affinity of the items regarding the estimated plurality of viewers. For example, if the estimation is that there are both male and female viewers and, with regard to age, if the 20s and 30s items exceed a prescribed threshold and, with regard to lifestyle, if the employed and non-employed items exceed a prescribed threshold, because there is a high possibility that, in view of the average Japanese household, the male is employed and the female is a housewife, the user demographic analysis unit 156 associates the employed item with male and associates the non-employed item with female.

Also, for example, the user demographic analysis unit 156 may analyze the user demographic using a known clustering method. For example, in the case of the k-nearest neighbor method, with regard to a viewer of a known demographic, a large amount of viewing history analysis data regarding viewing time slots, performers, target user demographic, and viewing medium is prepared as training data and plotted in a multidimensional space. In the same manner for a viewer-under-analysis, analysis data of the viewing history regarding viewing time slot, performers, target user demographic, and viewing medium is acquired and plotted in a multidimensional space. Then, based on a user demographic of a plurality of training data positioned nearby the data of the viewer-under-analysis, each item of the user demographic of the viewer-under-analysis is selected. The user demographic analysis unit 156 registers the selected user demographic information, in association with the user ID of the viewer-under-analysis, into the user information database.

### [Searching Service Providing Apparatus Constitution]

Next, the constitution of the searching service providing apparatus 6 will be described.

The block diagram of FIG. 10 shows an example of the functional constitution of the searching service providing apparatus 6.

The searching service providing apparatus 6 has a communication unit 61, a general searching unit 621, a recipe searching unit 622, a map searching unit 623, a product searching unit 624, and a restaurant searching unit 625.

The searching service providing apparatus 6 is, for example, a server apparatus having a known server function and, as described above, has therewithin a CPU and a storage device.

The communication unit 61 has a communication interface and communicates with the terminal device 2.

The general searching unit 621, the recipe searching unit 622, the map searching unit 623, the product searching unit 624, and the restaurant searching unit 625 have the functionality of searching mutually different ranges of data, and outputting the search results. Although the searching service providing apparatus 6 has, in addition to the general searching unit 621, the recipe searching unit 622, the map searching unit 623, the product searching unit 624, and the restaurant searching unit 625, many functional parts performing searches, because in the present embodiment there is no limitation with respect to the searched range and the form of the search results, the description herein will be limited to the above-noted functional parts, and the descriptions of the functional parts performing other searches will be omitted.

If the information indicating the searching service included in the search request received by the communication unit 61 indicates a general searching service, the general searching unit 621 performs a general search based on the search words included in the search request. Specifically, the general searching unit 621 searches for webpages including the search words. The general searching unit 621 transmits the search results to the terminal device 2 via the communication unit 61.

If the search request received by the communication unit 61 includes information indicating a recipe searching service, the recipe searching unit 622 performs a recipe search based on the search words included in the search request. Specifically, the recipe searching unit 622 performs a search, with the scope of the search limited to recipes. For example, the recipe searching unit 622 outputs the search results of public recipe sites with the search words. The recipe searching unit 622 transmits the search results to the terminal device 2 via the communication unit 61.

If the search request received by the communication unit 61 includes information indicating a map searching service, the map searching unit 623 performs a map search based on the search words included in the search request. Specifically, the map searching unit 623 performs a search of locations on maps related to the search words. For example, if a place name or building name is specified as the search words, the map searching unit 623 outputs maps of the area surrounding the search words as the search results. The map searching unit 623 transmits the search results to the terminal device 2 via the communication unit 61.

If the search request received by the communication unit 61 includes information indicating a product searching service, the product searching unit 624 performs a product search based on the search words included in the search request. Specifically, the product searching unit 624 outputs search results of shopping sites or product review sites. The product searching unit 624 transmits the search results to the terminal device 2 via the communication unit 61.

If the search request received by the communication unit 61 includes information indicating a restaurant searching service, the restaurant searching unit 625 performs a restaurant search based on the search words included in the search request. Specifically, the restaurant searching unit 625 outputs search results of sites presenting restaurants and restaurant review sites. The restaurant searching unit 625 transmits the search results to the terminal device 2 via the communication unit 61.

### [Information Processing Apparatus Operation]

Next, the operation of the information processing apparatus 1 will be described.

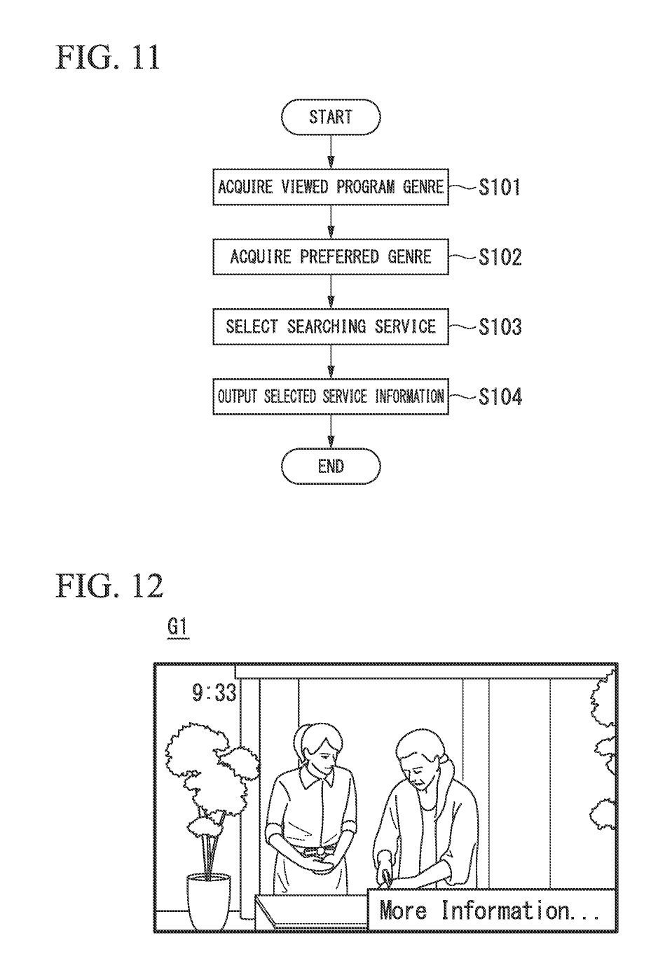

The flowchart of FIG. 11 shows an example of the flow of processing by the information processing apparatus to select a searching service.

First, the selection unit 16 of the information processing apparatus 1 acquires the genre of the viewed program that the viewer is watching (step S101). Specifically, the selection unit 16, using the user ID as a query, extracts records from the viewing history database and, of them, acquires the record having the latest viewing start time. The selection unit 16 acquires the channel item of the acquired record. The selection unit 16, using the acquired channel and the current time as queries, extracts a record from the program information database. The selection unit 16, by acquiring the genre item of the extracted record, acquires the genre of the program being watched by the viewer.

Next, the selection unit 16 acquires the preferred genre of the viewer (step S102). Specifically, the selection unit 16, using the user ID of the viewer as a query, extracts a record from the user information database. The selection unit 16, by acquiring the preferred genre item of the extracted record, acquires the preferred genre item of the viewer.

Next, the selection unit 16 acquires the priority of the searching services and selects a searching service (step S103). Specifically, the selection unit 16, using the viewed program genre acquired at step S101 and the preferred genre to be acquired at step 102 as a query, extracts a record from the searching service information database.

For example, in the example shown in FIG. 8, the “Preferred genres” of “Cooking”, “Travel”, and “Other” are associated with the “Viewed program genre” of “Cooking”. Further, the “Preferred genre” of “Cooking” has associated therewith “Recipe searching service”, which is “1st” and “Restaurant searching service”, which is “2nd”. Therefore, if the genre of the program being watched is “Cooking” and the preferred genre of the viewer is “Cooking”, the selection unit 16 extracts the record at line L11, selects the “Recipe searching service” as the searching service with 1st priority, and selects the “Restaurant searching service” as the searching service with 2nd priority.

In the example shown in FIG. 8, the “Preferred genres” of “Travel” with respect to the “Viewed program genre” of “Cooking” has associated therewith “Restaurant searching service”, which is “1st” and “Recipe searching service”, which is 2nd. Therefore, if the genre of the program being watched is “Cooking” and the preferred genre of the viewer is “Travel”, the selection unit 16 extracts the record at line L12, selects the “Restaurant searching service” as the searching service with 1st priority, and selects the “Recipe searching service” as the searching service with 2nd priority.

In the example shown in FIG. 8, the “Preferred genre” of “Other” regarding the “Viewed program genre” of “Cooking” has associated therewith the “General searching service”, which is 1st and the “Recipe searching service”, which is 2nd. Therefore, if the genre of the program being watched is “Cooking” and the preferred genre of the viewer does not include “Cooking” and “Travel”, the selection unit 16 extracts the record at line L13, selects the “General searching service” as the searching service with 1st priority, and selects the “Recipe searching service” as the searching service with 2nd priority.

The selection unit 16 transmits to the terminal device 2 selected service information indicating the selected searching service and the priority thereof (step S104) and ends processing. The processing of steps S101 to S104 is, for example, performed periodically.

### [Display Mode]

Next, the display mode made by the terminal device 2 will be described.

FIG. 12 shows the first example of the display mode made by the terminal device 2.

In the first example of the display mode, the display unit 22 displays a television broadcast program over the entire display region G1. The display unit 22 also displays a notice that searching is possible in the lower-right region G11 of the display region G1. For example, if a searching operation is not performed for at least a prescribed period of time, the notice in the region G11 may disappear.

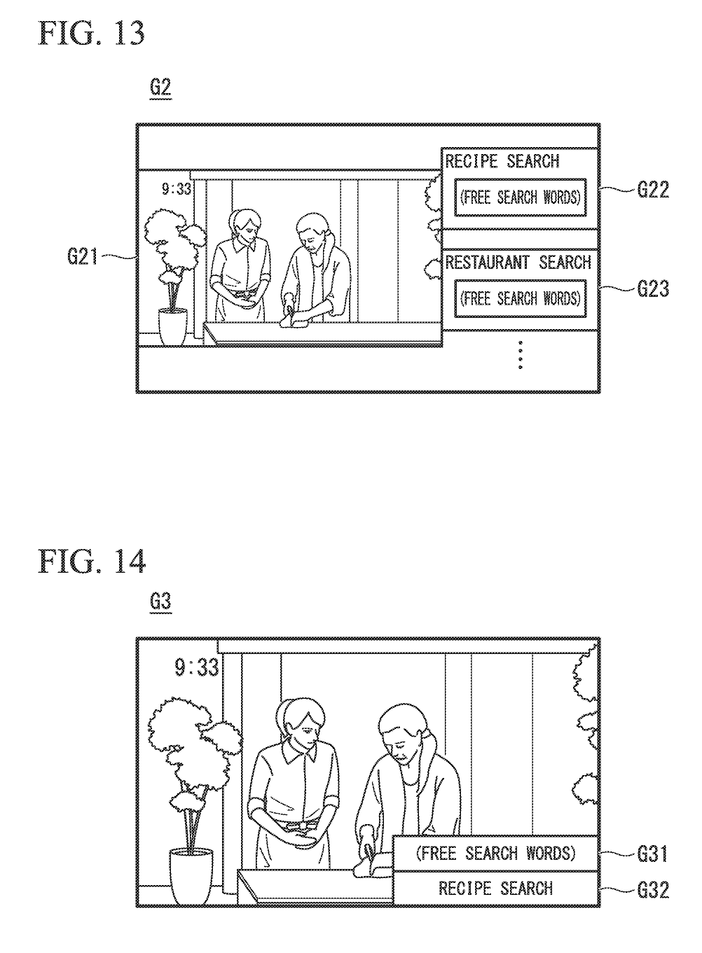

FIG. 13 shows the second example of the display mode made by the terminal device 2.

In the second example of the display mode, the display unit 22 displays a television broadcast program on the left-side region G21 of the display region G2 thereof. The display unit 22 also displays searching service interfaces in each of the upper-right region G22 and the lower-right region G23 of the display region G2. The display unit 22, for example, displays the interface of the searching service having the 1st priority indicated by the selected service information in the display region G22 and of the searching service having the 2nd priority indicated by the selected service information in the display region G23. The search results from these searching services are displayed, for example, in the regions G22 and G23, respectively. In the first example of the display mode, for example, when a searching service start button of a remote controller of the terminal device 2 is pressed, the display unit 22 transitions the display screen to the display mode of the second example.

In the example of FIG. 13, a program having the genre “Cooking” is displayed in the region G21, the interface for a recipe searching service is displayed in the region G22, and the interface for a restaurant searching service is displayed in the region G23. The preferred genre of the viewer, which is not illustrated, is “Cooking”. The searching services displayed in the region G22 and the region G23 are selected based on the example of the record of the searching service information database shown in FIG. 8. For example, if the preferred genre of the viewer is “Travel”, a restaurant searching service interface is displayed in the region G22 and a recipe searching service interface is displayed in the region G23.

FIG. 14 shows the third example of the display mode made by the terminal device 2.

In the third example of the display mode, the display unit 22 displays a television broadcast program over the entire display region G3 thereof. The terminal device 2 also provides three selectable regions G31, G32, and G33 in the lower-right part of the display region G3, and displays the interfaces for searching services. The display unit 22 displays in the display region G31 the search words input by a character input means such as a keyboard or the like of the terminal device 2. The display unit 22 displays the name of the searching service in the display region G32. The display unit 22 displays in the display region G32, for example, the name of the searching service having the 1st priority as indicated by the selected service information.

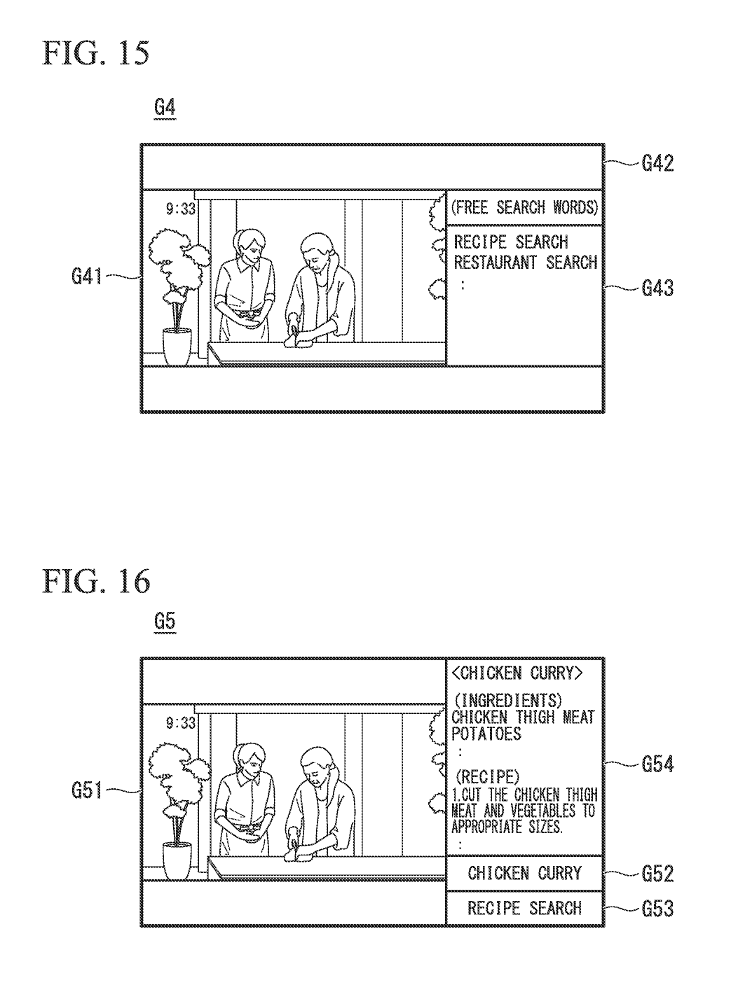

FIG. 15 shows the fourth example of the display mode made by the terminal device 2.

In the fourth example of the display mode, the display unit 22 displays a television broadcast program on the left-side region G41 of the display region G4 thereof. The terminal device 2 also provides two selectable regions G42 and G43 at the right side of the display region G4. The display unit 22 displays in the display region G42 the search words input by a character input means such as a keyboard or the like of the terminal device 2. The display unit 22 selectably displays in the display region G43 the names of a plurality of searching service. The display unit 22 displays in the display region G43, for example, the names of searching services indicated by the selected service information, in order of descending priority. The searching services display in the display region G43 can each be selected, the selected searching service providing a searching function.

FIG. 16 shows a fifth example of the display mode made by the terminal device 2.

In the fifth example of the display mode, the display unit 22 displays a television broadcast program on the left-side region G51 of the display region G5 thereof. The terminal device 2 provides three selectable regions G52, G53, and G54 at the right side of the display region G5.

The display unit 22 displays the search words in the region G52. The search words displayed in the region G52 are input by a character input means such as a keyboard or the like of the terminal device 2. The display unit 22 displays the name of a searching service in the region G53. The name of the searching service displayed in the region G53 is, for example, a name of the candidate searching service having the 1st priority received from the information processing apparatus 1. The display unit 22 displays the search results in the region G54. The search results displayed in the region G54 are, for example, the results of a search using the searching service displayed in the region G53 regarding the search words displayed in the region G52. For example, in the second, third, and fourth examples of the display mode, if a search word is input and an instruction is made to execute a search, the display unit 22 transitions the screen display to the display mode of the fifth example.

In the example shown in FIG. 16, “Chicken curry” is displayed in the region G52, and “Recipe search” is displayed in the region G53. The region G54 displays a chicken curry recipe that is the search result of searching for the search words “Chicken curry” using the “Recipe search” searching service.

### [Effect]

As described above, the information processing apparatus 1 according to the present embodiment has a viewing information acquisition unit 14 that acquires viewing information indicating the state of television broadcast viewing by a viewer, a selection unit 16 that acquires from a storage unit 11 correspondence information indicating a correspondence between a searching service that searches information of a prescribed field and viewing information, and that, based on the acquired correspondence information and the viewing information acquired by the viewing information acquisition unit, selects the searching service, and a communication unit 12 that outputs selected service information indicating the searching service selected by the selection unit 16.

This enables the information processing apparatus 1 to have the selection of the searching service reflect each of the television broadcast viewing states for each viewer from the viewing states of the viewer. Therefore, the information processing apparatus 1 is able to provide a searching service that is suitable for each viewer.

The correspondence information includes a first correspondence information associating viewer attributes with the searching services and a second correspondence information associating viewer attributes with viewing information. The information processing apparatus 1 has an analysis unit 15 that analyzes viewer attributes, based on correspondence information acquired from the storage unit 11 and viewing information acquired by the viewing information acquisition unit 14, and the selection unit 16 selects the searching service, based on the correspondence information acquired from the storage unit 11 and the viewer attributes analyzed by the analysis unit 15.

By doing this, the information processing apparatus 1 analyzes what type of person the viewer is. Also, the information processing apparatus 1 selects and provides a searching service of interest to a user demographic to which a viewer belongs or a searching service related to the preferences of a viewer. Therefore, the information processing apparatus 1 can provide a searching service more suitable for each individual viewer.

The analysis unit 15, by classifying viewers into any one of a plurality of groups, analyzes the user demographic, which is one example of a viewer attribute.

By doing this, the information processing apparatus 1 provides a searching service suitable for the user demographic of a viewer, enabling the provision of a searching service more suitable for each individual viewer.

The analysis unit 15, by extracting viewer characteristics, analyzes the preferred genre, which is an example of a viewer attribute.

By doing this, the information processing apparatus 1 provides a searching service suitable for characteristics such as the preference of a viewer, enabling the provision of a searching service more suitable for each individual viewer.

The correspondence information includes a third correspondence information associating the searching services with their priorities.

By doing this, because the information processing apparatus 1 prioritizes the searching service suitable for a viewer and provides the prioritized searching services, it is possible, for example, for a viewer to easily grasp which searching service of a plurality of searching services is suitable for him or her, enabling the provision of a searching service more suitable for each individual viewer.

Also, the analysis unit 15 estimates at least one of the age, gender, and lifestyle of a viewer and, based on the estimation result, analyzes the viewer attributes by classifying the viewers into any one of a plurality of groups.

By doing this, the information processing apparatus 1 provides a searching service suitable for the age, gender, or lifestyle of the viewer, enabling the provision of a searching service more suitable for each individual viewer.

The analysis unit 15 extracts the genre of programs preferred by a viewer as a characteristic of a viewer, to analyze the viewer attributes.

By doing this, the information processing apparatus 1 provides a searching service suitable for the program genre preferred by the viewer, enabling the provision of a searching service more suitable for each individual viewer.

The terminal device 2 has the display unit 22 and the display control unit 254 that causes the display unit 22 to display a searching service indicating by the selected service information output by the information processing apparatus, thereby enabling presentation of a searching services suitable for each individual viewer.

### Second Embodiment

### System Constitution

The second embodiment of the present invention will be described below, with references made to the drawings.

Comparing the information processing system according to the present embodiment with the information processing system S1 according to the first embodiment, the format of the data managed by the searching service information database of the information processing apparatus and the processing for selection of a searching service by the selection unit of the information processing apparatus are different. In the present embodiment, the other functions of the information processing apparatus, and the functions of the terminal device 2, the program information providing apparatus 3, the viewing information server apparatus 4, the display template server apparatus 5, and the searching service providing apparatus 6 are the same as in the first embodiment. In the following, each of these constituent elements is assigned the same reference numeral as in the first embodiment, and the descriptions of the functions that are the same as in the first embodiment will be omitted.

### [Information Processing Apparatus Constitution]

The searching service information database storage unit 114 according to the present embodiment, similar to the searching service information database storage unit 114 according to the first embodiment, stores a searching service information database that manages searching service information and priorities. However, the searching service information database according to the present embodiment manages correspondence information that associates the preferred genres, the user demographics, the searching services, and the priorities.

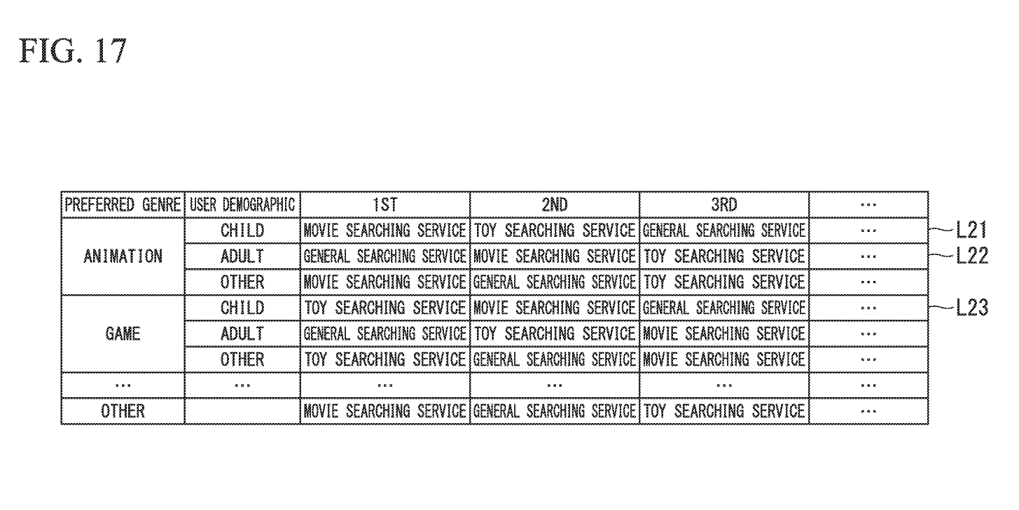

FIG. 17 shows an example of the associations between the searching service information and priorities managed by the searching service information database.

A record managed by the searching service information database has the items “Preferred genre” and “User demographic” and the searching service information of each priority (1st, 2nd, 3rd, . . . ). “Preferred genre” indicates the genre preferred by the viewer. “User demographic” indicates the user demographic of the viewer. “Viewed program genre” and “Preferred genre” are indicated as any of the items given as examples in the description of “Genre” of the program information or “Other”. “1st”, “2nd”, and “3rd” indicate, respectively, the searching services of the 1st, 2nd, and 3rd priorities.

The selection unit 16 selects the searching service based on the correspondence information in the searching service information database and on the viewer attributes analyzed by the analysis unit 15. The selection unit 16 acquires from the user information database the preferred genre and the user demographic of the viewer to whom the searching service is to be provided. The selection unit 16, based on the acquired user demographic and preferred genre, selects a searching service in association with the priority from the searching service information database and transmits selected service information indicating the selected searching service to the terminal device 2 via the communication unit 12.

### [Information Processing Apparatus Operation]

Next, the operation of the information processing apparatus 1 will be described.

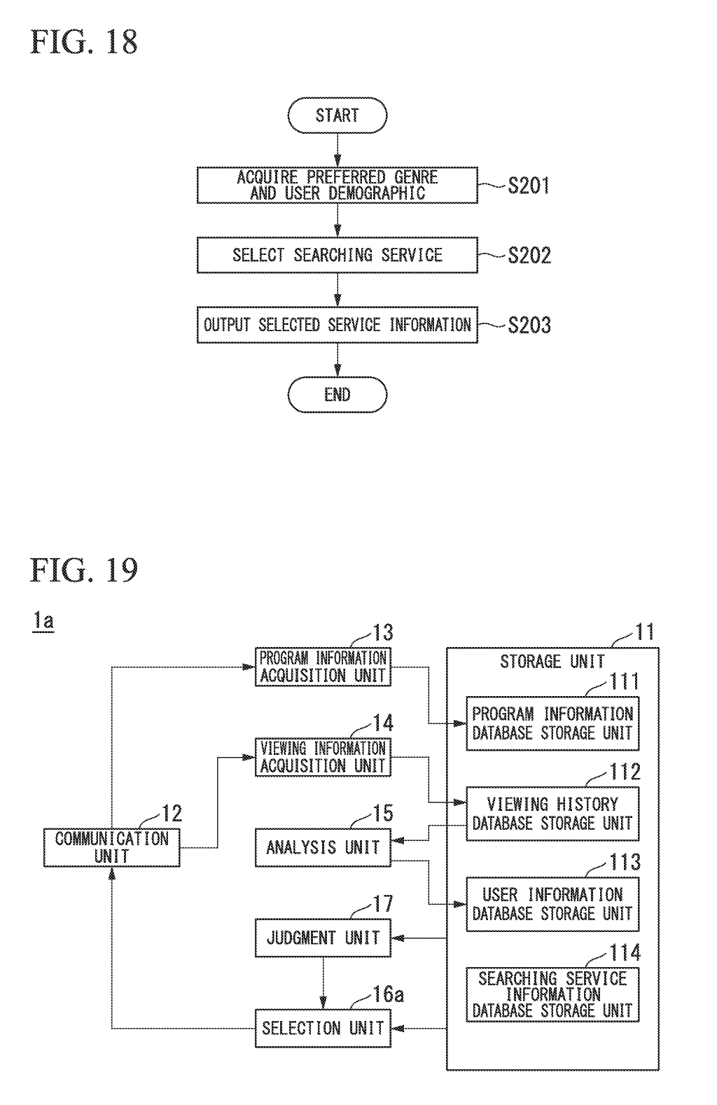

The flowchart of FIG. 18 shows an example of the flow of the processing performed by the information processing apparatus 1 to select a searching service information according to the second embodiment.

First, the selection unit 16 of the information processing apparatus 1 acquires the preferred genre of the viewer and the user demographic (step S201). Specifically, the selection unit 16, using the user ID of the viewer as a query, extracts a record from the user information database and, by acquiring the preferred genre item and the user demographic item from the extracted record, acquires the preferred genre of the viewer and the user demographic.

Next, the selection unit 16 acquires the priority of the searching services and selects a searching service (step S202). Specifically, the selection unit 16, using the preferred genre and the user demographic acquired at step S201 as a query, extracts a record from the searching service information database.

In the example shown in FIG. 17, “User demographic” of “Child”, “Adult”, and “Other” are associated with the “Preferred genre” of “Animation”. The “Preferred genre” of “Animation” and “User demographic” of “Child” have associated with them the “Movie searching service” as “1st”, the “Toy searching service” as “2nd”, and the “General searching service” as “3rd”. Therefore, if the preferred genre of the viewer is “Animation” and the user demographic is “Child”, the selection unit 16 extracts the record at line L21, selects “Movie searching service” as the searching service with the 1st priority, selects the “Toy searching service” as the searching service with the 2nd priority, and selects “General searching service” as the searching service with the 3rd priority.

In the example shown in FIG. 17, the “Preferred genre” of “Animation” and “User demographic” of “Adult” have associated with them “General searching service” as “1st”, “Movie searching service” as “2nd”, and “Toy searching service” as “3rd”. Therefore, if the viewer preferred genre is “Animation” and the user demographic is “Adult”, the selection unit 16 extracts the record at line L22, selects “General searching service” as the searching service with the 1st priority, selects “Movie searching service” as the searching service with the 2nd priority, and selects “Toy searching service” as the searching service with the 3rd priority.

In the example shown in FIG. 17, the “User demographic” of “Child”, “Adult”, and “Other” are associated with the “Preferred genre” of “Game”. The “Preferred genre” of “Game” and the “User demographic” of “Child” have associated with them “Toy searching service” as “1st”, “Movie searching service” as “2nd” and “General searching service” as 3rd. Therefore, if the viewer preferred genre is “Game” and the user demographic is “Child”, the selection unit 16 extracts the record at Line L23, selects “Toy searching service” as the searching service with the 1st priority, selects “Movie searching service” as the searching service with the 2nd priority, and selects “General searching service” as the searching service with the 3rd priority.

The selection unit 16 then transmits selected service information indicating the selected searching services and the priority thereof to the terminal device 2 (step S203) and ends processing. The processing of steps S201 to S203 is, for example, performed periodically.

### Third Embodiment

### System Constitution

The third embodiment of the present invention will be described in detail below, with references made to the drawings.

Comparing the information processing apparatus according to the present embodiment with the information processing system S1 according to the first embodiment, the constitution of the information processing apparatus is partially different. In the present embodiment, the functions of the terminal device 2, the program information providing apparatus 3, the viewing information server apparatus 4, the display template server apparatus 5, and the searching service providing apparatus 6 are the same as in the first embodiment. In the following, each of those constituent elements that are the same as in the first embodiment is assigned the same reference numeral, and the descriptions thereof will be omitted.

### [Information Processing Apparatus Constitution]

The constitution of the information processing apparatus 1a will be described below.

The block diagram of FIG. 19 shows an example of the functional constitution of the information processing apparatus 1a according to the present embodiment.

The information processing apparatus 1a has the storage section 11, the communication unit 12, the program information acquisition unit 13, the viewing information acquisition unit 14, the analysis unit 15, a selection unit 16a, and a judgment unit 17.

The selection unit 16a and the judgment unit 17 function by the execution by a CPU of the information processing apparatus 1a of programs stored in the storage unit 11.

The selection unit 16a according to the present embodiment has the function of the selection unit 16 of the information processing apparatus 1 in the first embodiment. However, upon acceptance of a searching service selection request from the judgment unit 17, the selection unit 16a selects a searching service and outputs selected service information to the terminal device 2.

The judgment unit 17 performs processing to judge whether or not to output selected service information. The judgment unit 17 references the viewing history database and the program information database and acquires the genre of the viewed program watched by the viewer. The judgment unit 17 references the user information database and acquires the preferred genre of the viewer. The judgment unit 17 compares the acquired viewed program genre and the viewer preferred genre and judges whether or not there is agreement therebetween. If there is agreement between the viewed program genre and the viewer preferred genre, the judgment unit 17 outputs a searching service selection request to the selection unit 16a.

### [Information Processing Apparatus Operation]

The operation of the information processing apparatus 1a will be described below.

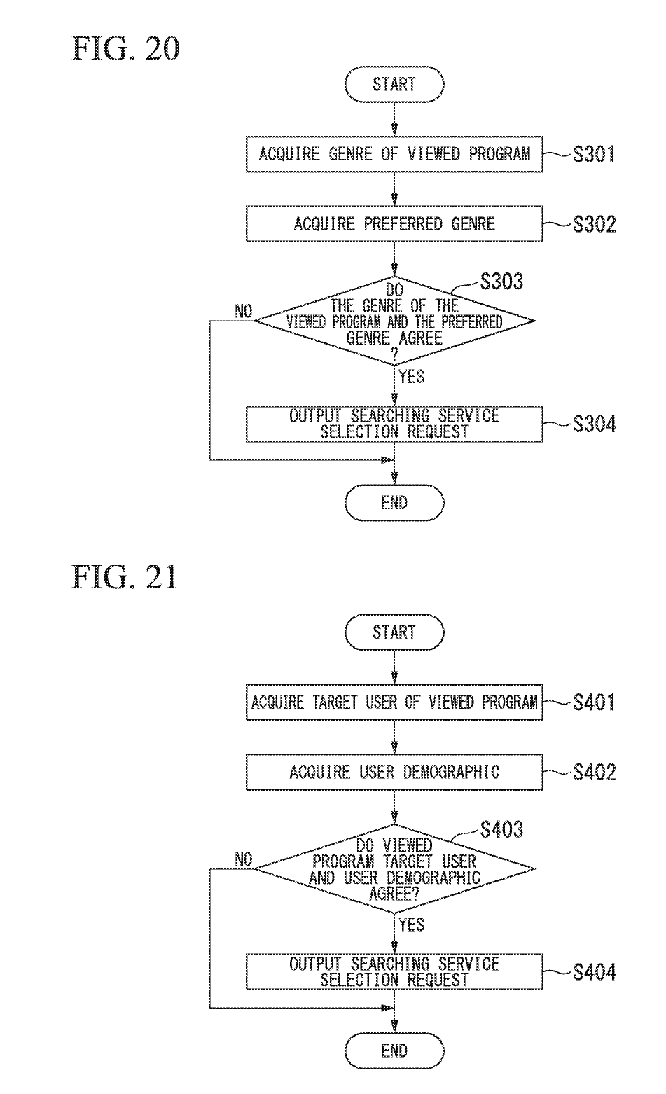

The flowchart of FIG. 20 shows an example of the processing performed by the information processing apparatus 1a to judge whether or not to output selected service information.

First, the judgment unit 17 of the information processing apparatus 1a acquires the genre of the viewed program being watched by viewer (step S301). Next, the judgment unit 17 acquires the preferred genre of the viewer (step S302). The specific processing of steps S301 and S302 may be executed as described regarding steps S101 and S102 of FIG. 11.

Next, the judgment unit 17 compares the genre of the viewed program and the preferred genre acquired in the steps S301 and S302, respectively, to judge whether they agree (step S303). For example, if the genre of the viewed program is cooking and the preferred genre of the viewer is “Cooking”, the judgment unit 17 judges that they agree. If, for example, the genre of the viewed program is “Cooking” and “Travel” and the preferred genre of the viewer is “Cooking”, the judgment unit 17 may judge this to be agreement, or may judge this to be non-agreement. In this manner, if there is partial agreement between the viewed program genre and the preferred genre of the viewer, the judgment unit 17 may judge agreement, or alternatively may judge agreement only if there is total agreement.

If there is agreement between the viewed program genre and the preferred genre of the viewer (YES at step S303), the judgment unit 17 outputs a searching service selection request to the selection unit 16a (step S304) and ends processing. If there is no agreement between the viewed program genre and the preferred genre of the viewer (NO at step S303), the judgment unit 17 ends processing.

### [Effect]

As described above, the information processing apparatus 1a according to the present embodiment has a judgment unit 17 that, based on the viewer attributes analyzed by the analysis section 15, judges whether or not to output selected service information to the communication unit 12, thereby enabling the provision of a searching service at an appropriate time for each individual viewer.

### Fourth Embodiment

### System Constitution

The fourth embodiment of the present invention will be described in detail below, with references made to the drawings.

Comparing the information processing system of the present embodiment with the information processing system according to the third embodiment, judgment processing by the judgment unit of the information processing apparatus is different. In the present embodiment, the other functions of the information processing apparatus and the functions of the terminal device 2, the program information providing apparatus 3, the viewing information server apparatus 4, the display template server apparatus 5, and the searching service providing apparatus 6 are the same as in the third embodiment. In the following, each of these constituent elements is assigned the same reference numeral as in the third embodiment, and the descriptions of the functions that are the same as in the third embodiment will be omitted.

### [Information Processing Apparatus Constitution]

The constitution of the information processing apparatus 1a will be described below.

The judgment unit 17 performs processing to judge whether or not to output selected service information. The judgment unit 17 references the viewing history database and the program information database and acquires the target user demographic of the viewed program that the viewer is watching. The judgment unit 17 references the user information database and acquires the user demographic of the viewer. The judgment unit 17 compares the acquired viewed program target user demographic and the user demographic of the viewer and judges whether or not they agree. If the viewed program genre and the preferred genre agree, the judgment unit 17 outputs a searching service selection request to the selection unit 16a.

### [Information Processing Apparatus Operation]

Next, the operation of the information processing apparatus 1a will be described.

The flowchart of FIG. 21 shows an example of the processing by the information processing apparatus 1a to judge whether or not to output selected service information.

First, the judgment unit 17 of the information processing apparatus 1a acquires the target user demographic of the viewed program being watched by the viewer (step S401). Specifically, the selection unit 16a, using the user ID as a query, extracts records from the viewing history database and, of them, acquires the record having the latest viewing start time. The selection unit 16a acquires the channel item of the acquired record. The selection unit 16a, using the acquired channel and the current time as queries, extracts a record from the program information database. The selection unit 16a, by acquiring the target user demographic item of the extracted record, acquires the genre of the program being watched by the viewer.

Next, the judgment unit 17 acquires the user demographic of the viewer (step S402). Specifically, the judgment unit 17, using the user ID of the viewer as a query, extracts a record from the user information database. The selection unit 16a, by acquiring the user demographic item of the extracted record, acquires the user demographic of the viewer.

Next, the judgment unit 17 compares the target user demographic of the viewed program and the user demographic of the viewer acquired at steps S401 and S402, respectively, and judges whether or not they agree (step S403). In this case, if there are a plurality of target user demographics and viewer user demographics, if there is even partial agreement thereof, the judgment of agreement may be made. Alternatively, the judgment unit 17 may judge agreement only if there is agreement between all the target user demographics and the viewer user demographics. If there is agreement between the target user demographic of the viewed program and the user demographic of the viewer (YES at step S403), the judgment unit 17 outputs a searching service selection request to the selection unit 16a (step S404) and ends the processing. If there is not agreement between the viewed program target user demographic and the user demographic of the viewer (NO at step S403), the judgment unit 17 ends the processing.

### Fifth Embodiment

### System Constitution

The fifth embodiment of the present invention will be described in detail below, with references made to the drawings.

Comparing the information processing system according to the present embodiment with the information processing system according to the third embodiment, the information processing system according to the present embodiment is partially different with regard to the constitution of the information processing apparatus. In the present embodiment, the functions of the terminal device 2, the program information providing apparatus 3, the viewing information server apparatus 4, the display template server apparatus 5, and the searching service providing apparatus 6 are the same as in the third embodiment. In the following, each of these constituent elements is assigned the same reference numeral as in the third embodiment, and the descriptions of the functions that are the same as in the third embodiment will be omitted.

### [Information Processing Apparatus Constitution]

The constitution of the information processing apparatus 1b will now be described.

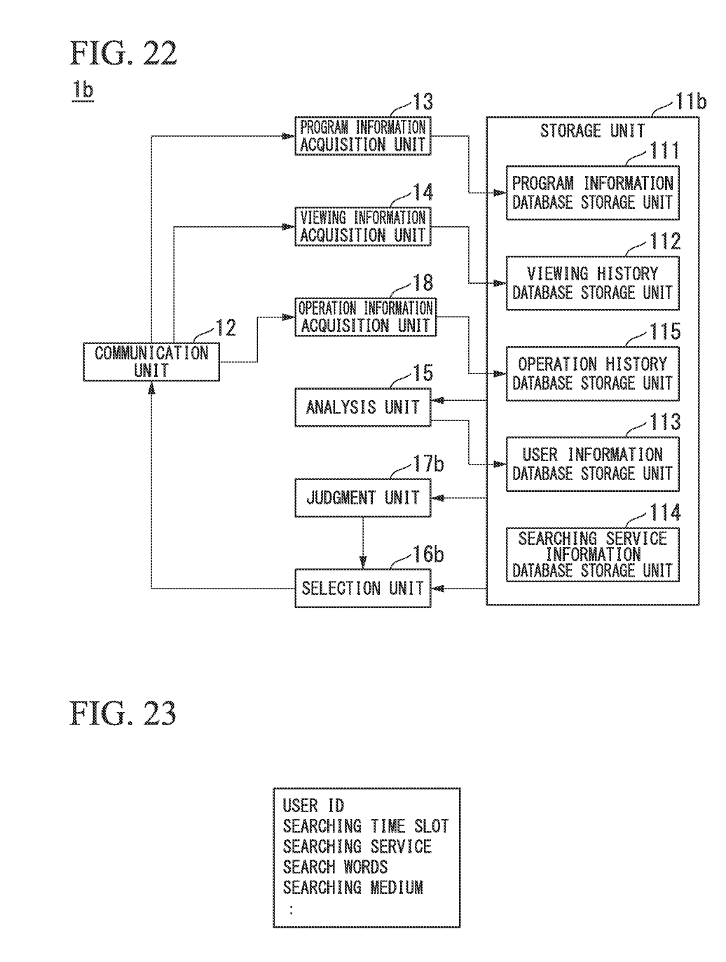

The block diagram of FIG. 22 shows an example of the functional constitution of the information processing apparatus 1b according to the present embodiment.

The information processing apparatus 1b has a storage unit 1b, the communication unit 12, the program information acquisition unit 13, the viewing information acquisition unit 14, the analysis unit 15, a selection unit 16b, a judgment unit 17b, and an operation information acquisition unit 18.

The storage unit 11b according to the present embodiment has the same function as the storage unit 11 according to the third embodiment. The storage unit 11b has the program information database storage unit 111, the viewing history database storage unit 112, the user information database storage unit 113, the searching service information database storage unit 114, and an operation history database storage unit 115.

The operation history database storage unit 115 stores an operation history database that manages operation information.

FIG. 23 shows an example of the operation information managed by the operation history database.

The operation information managed by the operation history database has the items “User ID”, “Searching time slot”, “Searching service”, “Search words”, and “Searching medium”.

“User ID” is the same as “User ID” in viewing information. “Searching time slot” indicates the time slot in which the viewer uses a searching service to execute a search. The time slot divides one day into classes by times, such as morning, midday, evening, late evening, and early morning. Alternatively, for example, the time slots may divide one day into 30-minute units or 1-hour units, thereby dividing the day into classes of a prescribed time interval. “Searching service” indicates a searching service specified when a viewer executes a search. “Search words” indicates the search words specified when a viewer executes a search. “Searching medium” indicates the type of the terminal device 2 used by the viewer who performs searches, for example, items such as television, personal computer, mobile telephone, tablet, smartphone, or PDA.

The selection unit 16b, the judgment unit 17b, and the operation information acquisition unit 18 according to the present embodiment function by the execution by the CPU of the information processing apparatus 1b of programs stored in the storage unit 11b.

The operation information acquisition unit 18 acquires operation information from the viewing information server apparatus 4 via the communication unit 12 and registers the acquired operation information into the operation history database.

The selection unit 16b according to the present embodiment has the same function as the selection unit 16 of the information processing apparatus 1a according to the third embodiment.

The judgment unit 17b according to the present embodiment performs processing to judge whether or not to output selected service information. The judgment unit 17b acquires the current time slot and judges whether or not a search has been made in the current time slot in the past. If a search had been made in the current time slot in the past, the judgment unit 17b outputs a searching service selection request to the selection unit 16b.

### [Information Processing Apparatus Operation]

Next, the operation of the information processing apparatus 1b will be described.

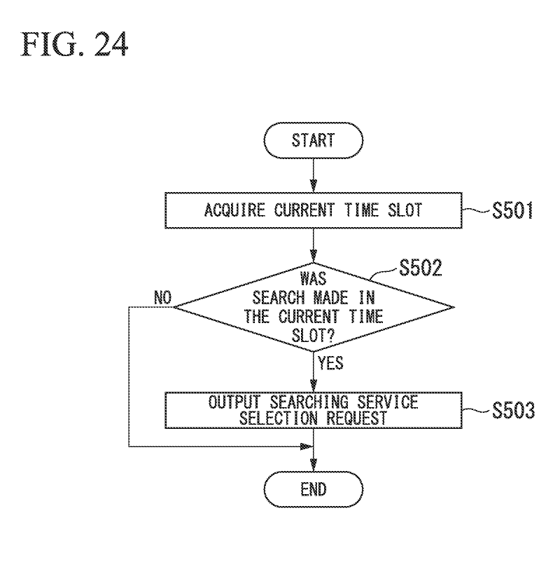

The flowchart of FIG. 24 shows an example of the processing by the information processing apparatus 1b to judge whether or not to output selected service information.

First, the judgment unit 17b of the information processing apparatus 1b acquires the current time slot (step S501). Specifically, the judgment unit 17b acquires the current time. The judgment unit 17b, based on the acquired current time, acquires the time slot to which the current time belongs. The time slot is a time slot of a search time slot in the operation information, this being, for example, morning, midday, evening, late evening, or early morning.

Next, the judgment unit 17b judges whether or not a search was made in the current time slot (step S502). Specifically, the judgment unit 17b, using the current time slot acquired at step S501 as a query, judges whether or not a corresponding records exists in the operation history database. If the record exists, the judgment unit 17b judges that a search was made in the current time slot.

If a search was made in the current time slot (YES at step S502), the judgment unit 17b outputs a searching service selection request to the selection unit 16b (step S503) and ends the processing. If a search was not made in the current time slot (NO at step S502), the judgment unit 17b ends the processing.

### Sixth Embodiment

### System Constitution

The sixth embodiment of the present invention will be described in detail below, with references made to the drawings.

Comparing the information processing system of the present embodiment with the information processing system according to the fifth embodiment, the analysis processing by the analysis unit of the information processing apparatus and the form of the display by the terminal device are different. In the present embodiment, the other functions of the information processing apparatus and the terminal device and the functions of the program information providing apparatus 3, the viewing information server apparatus 4, the display template server apparatus 5, and the searching service providing apparatus 6 are the same the same as in the fifth embodiment. In the following, each constituent element that is the same as in the fifth embodiment is assigned the same reference numeral, and the description thereof will be omitted.

### [Information Processing Apparatus Constitution]

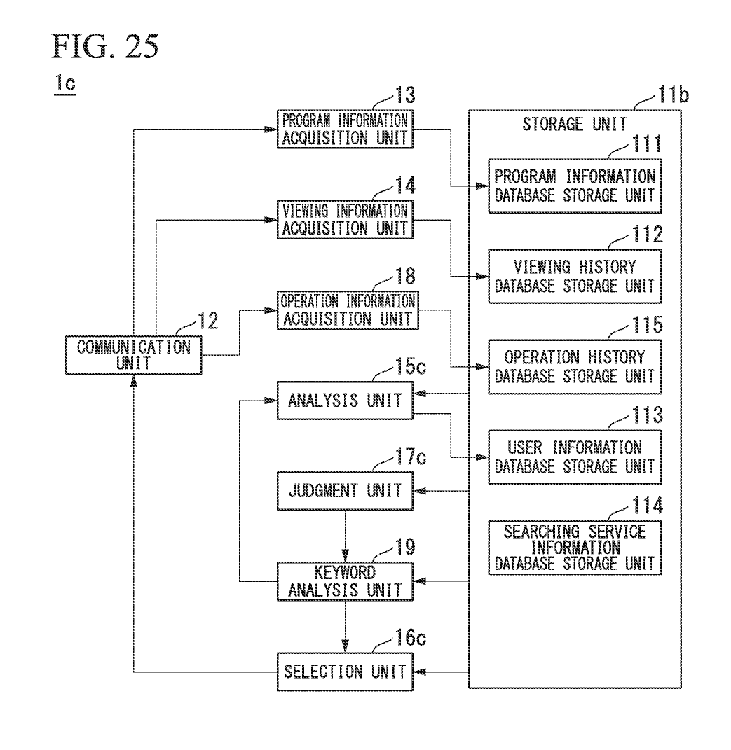

The block diagram of FIG. 25 shows an example of the functional constitution of an information processing apparatus 1c according to the present embodiment.

The information processing apparatus 1c has the storage unit 11b, the communication unit 12, the program information acquisition unit 13, the viewing information acquisition unit 14, the analysis unit 15, a selection unit 16c, a judgment unit 17c, the operation information acquisition unit 18, and a keyword analysis unit 19.

The analysis unit 15c, the selection unit 16c, the judgment unit 17c, and the keyword analysis unit 19 according to the present embodiment function by the execution by the CPU of the information processing apparatus 1c of programs stored in the storage unit 11b.

The analysis unit 15c according to the present embodiment has the same function as the analysis unit 15 according to the fifth embodiment. However, the analysis unit 15c acquires from the keyword analysis unit 19 information of a keyword characteristic to the viewer and analyzes the user demographic and the preferred genre, including that keyword information. For example, the analysis unit 15c, based on a table associating keywords and the user demographics, adds points to each user demographic corresponding to the keyword acquired from the keyword analysis unit 19. The analysis unit 15c uses the number of points to estimate the user demographic based on the number of points for each user demographic as described regarding the first embodiment.

The selection unit 16c according to the present embodiment has the same function as the selection unit 16b according to the fifth embodiment. However, when a searching service selection request including a search word candidate is accepted from the keyword analysis unit 19, the selection unit 16c selects a searching service. The selection unit 16c outputs to the terminal device 2 selected service information that includes the search word candidates acquired from the keyword analysis unit 19 and the selected searching services. If a priority is assigned to the search word candidates, the search word candidates and the priorities thereof are output to the terminal device 2.

The judgment unit 17c of the present embodiment has the same function as the judgment unit 17b according to the fifth embodiment. However, the judgment unit 17c outputs a searching service selection request to the keyword analysis unit 19.

The keyword analysis unit 19 generates a plurality of search word candidates and assigns priorities to the generated plurality of search word candidates. The keyword analysis unit 19 outputs to the selection unit 16c a searching service selection request that includes the generated plurality of search word candidates and the priorities thereof. The keyword analysis unit 19 acquires from the viewing history database the viewing information of a viewer-under-analysis and, based on the viewing history indicated by the viewing information, analyzes the keywords characteristic to the viewer and outputs information indicating the keywords to the analysis unit 15c.

The keyword analysis unit 19, for example, based on the user ID, extracts the keywords of a program being watched by the viewer-under-analysis from the viewing history database. The keyword analysis unit 19, based on the extracted keywords, extracts a record from the viewing history database. The keyword analysis unit 19, for example, compares the frequency of occurrences of a specific keyword in the viewing history for the viewer-under-analysis with the frequency of occurrence of the keyword in the viewing history of a plurality of viewers other than the viewer-under-analysis. The keyword analysis unit 19 then selects keywords that have a high frequency of occurrence in the viewing history of the viewer-under-analysis and a low frequency of occurrence in the viewing history of the plurality of viewers other than the viewer-under-analysis. The keyword analysis unit 19 generates keywords that are similar to or related to the selected keywords, and outputs to the analysis unit 15c information of the selected keywords and the generated keywords as information of keywords characteristic to the viewer-under-analysis. The keyword analysis unit 19 may be included in a part of the analysis unit 15c.

The keyword analysis unit 19 assigns priorities to each of the keywords as search word candidates. Priority is assigned, for example, based on the frequency of use of the keyword as a search word, or the similarity or association between the generated keywords and the selected keywords. The keyword analysis unit 19 outputs to the selection unit 16c a searching service selection request that includes the search word candidates and the priorities thereof.

### [Display Mode]

Next, the display mode made by the terminal device 2 according to the present embodiment will be described.

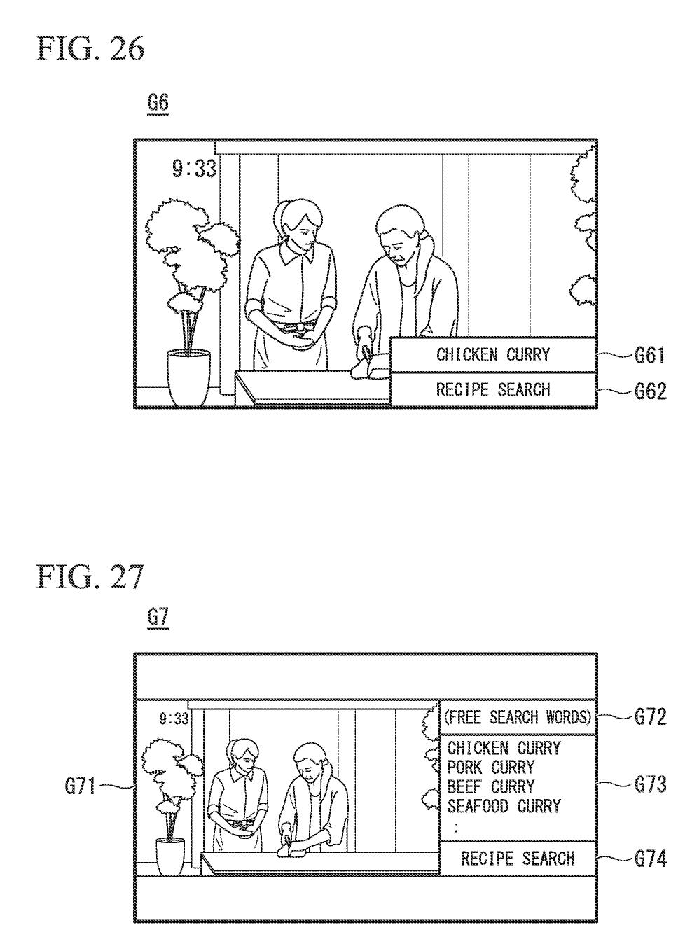

FIG. 26 shows the sixth example of the display mode made by the terminal device 2.

In the sixth example of the display mode, the display unit 22 displays a television broadcast program over the entire display region G6. The terminal device 2 also provides the two selectable regions G61 and G62 in the lower-right part of the display region G6. The display unit 22 displays the search word candidate in the region G61. The search word displayed in the region G61 is, for example, the search word candidate having the 1st priority received from the information processing apparatus 1c. In the example shown in FIG. 26, “Chicken curry” is displayed in the region G61. The display unit 22 displays the name of the searching service in the region G62. The name of the searching service displayed in the region G62 is, for example, the searching service candidate having the 1st priority received from the information processing apparatus 1c. In this manner, the terminal device 2 displays the search word candidate and the searching service selected by the information processing apparatus 1c.

FIG. 27 shows the seventh example of the display mode made by the terminal device 2.

In the seventh display mode, the display unit 22 displays a television broadcast problem on the left-side region G71 of the display region G7 thereof. The terminal device 2 also provides the three selectable regions G72, G73, and G74 on the right side of the display region G7. The display unit 22 displays in the region G72 the search words input by a character input means such as a keyboard. The display unit 22 displays in the region G73, a plurality of selectable search word candidates, and also displays, for example, a plurality of search word candidates received from the information processing apparatus 1c, in order of descending priority. The display unit 22 displays the name of the searching service in the region G74. The name of the searching service displayed in the region G74 is, for example, the name of the searching service having the 1st priority received from the information processing apparatus 1c. For example, in the sixth example of the display mode, if the region G61 is selected, the display unit 22 transitions the display screen to the display mode of the seventh example.

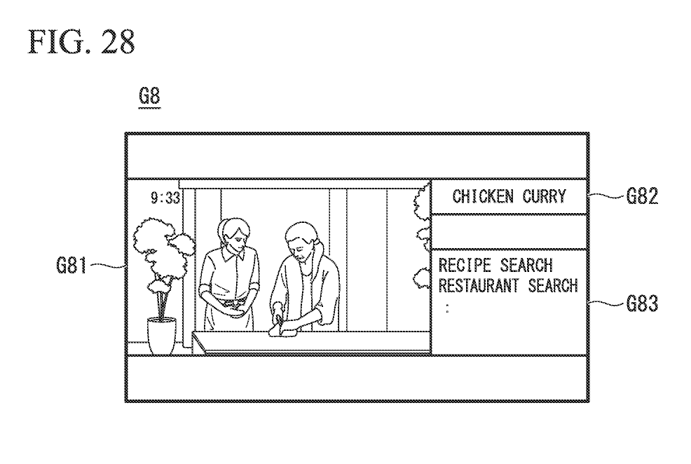

FIG. 28 shows the eighth example of the display mode made by the terminal device 2.

In the eighth example of the display mode, the display unit 22 displays a television broadcast program on the left-side region G81 of the display region G8 thereof. The terminal device 2 also provides two selectable region G82 and G83 on the right side of the display region G8. The display unit 22 displays a search word candidate in the region G82. The name of search service displayed in the region G82 is, for example, the search word candidate having the 1st priority received from the information processing apparatus 1c. The display unit 22 selectably displays in the region G83 the names of a plurality of searching services. The display unit 22 displays in the region G83, for example, the names of a plurality of searching services received from the information processing apparatus 1c, in order of descending priority. For example, in the sixth example of the display mode, if the region G62 is selected, the display unit transitions the display screen to the display mode of the eight example.

The terminal device 2 may display the search results based on information of the search word candidates and searching services received from the information processing apparatus 1c. For example, if the terminal device 2 receives information of the search word candidate and the searching service, it displays the search results of performing a search using the searching service having 1st priority, based on the search word having the first priority. In this case, the mode of the display screen may be, for example, the display as in the above-described fifth example.

### [Effect]

As described above, the information processing apparatus 1c according to the present embodiment further has an operation information acquisition unit 18 that acquires operation information indicating the utilization state of searching services by the viewer, and the judgment unit 17c judges, based on the operation information acquired by the operation information acquisition unit 18, whether or not the selected service information is to be output to the communication unit 12.

By doing this, the information processing apparatus 1c provides, for example, a searching service in a time slot in which the viewer has in the past used the searching service, thereby enabling the provision of a searching service at a time when there is a high possibility that individual viewers desire to use a searching service.

The analysis unit 15c analyzes the attributes of a viewer by extracting keywords related to programs the viewer prefers as a viewer characteristic, and the communication unit 12 outputs keywords extracted by the keyword analysis unit 19 as search word candidates.

By doing this, the information processing apparatus 1c outputs keywords in which the viewer interest is high as search word candidates, thereby enabling the provision of a searching service more suitable for individual viewers, while eliminating the need for each viewer to think about search words.

The display control unit 254 causes the search word candidates output by the information processing apparatus 1c to be displayed by the display unit 22, thereby enabling the terminal device 2 to provide searching services suitable for individual viewers.

The display control unit 254, in response to the search word candidates output by the information processing apparatus 1c, displays on the display unit 22 the results of search processing executed by a searching service indicated by the selected service information output by the information processing apparatus 1c. This enables the terminal device 2 to provide search results suitable for each individual viewer.

In the searching service information database of the above-described embodiments, the searching service information need not be associated with priorities, in which case, for example, the searching service information may be uniquely associated with the viewer user demographic and preferred genre. Also, for example, if the viewer has a plurality of preferred genres, the degree of preference may be evaluated and the searching service may be selected based on a preferred genre that has a higher level of preference. The information processing apparatuses 1, 1a, 1b, and 1c may select a searching service based on only any one of the preferred genres, or user demographic, in which case the information processing apparatuses 1a, 1b, and 1c need not have a function that analyzes the whichever of the preferred genre or user demographic is not used in the processing to select a search word or the processing to judge whether or not to output selected service information. The information processing apparatuses 1, 1a, 1b, and 1c may select the searching service based on a part or all of the program information of the viewed program, the characteristics of the viewer, such as the preferred genre, and the user demographic.

In the searching service information database, the association of the viewer characteristics with the searching service information may be made for each time slot. For example, if the viewers are estimated to be in a household made up of a businessman and a housewife, because it can be envisioned that the person mainly watching programs will differ depending upon the time slot, even for the watching of a program in the same genre, the information processing apparatuses 1, 1a, 1b, and 1c may change the searching service that is selected.

The searching service interface may have searching options, and more detailed search conditions may be set. The information processing apparatus 1c may change the provided search words for each searching service.

The information processing apparatuses 1, 1a, 1b, and 1c may, for example, analyze the attributes of a viewer based on the names of programs in the viewing history. The information processing apparatuses 1, 1a, 1b, and 1c may analyze the attributes of a viewer based on the program genre, and may analyze the attributes of a viewer based on a segment genre. The information processing apparatuses 1, 1a, 1b, and 1c may analyze the attributes of a viewer based on the search words used by and on the search results viewed by the viewer. In this manner, the information processing apparatuses 1, 1a, 1b, and 1c may use any information included in the broadcast program information in analyzing viewer attributes.

The information processing apparatuses 1, 1a, 1b, and 1c may analyze viewer attributes based on the program information of a program that was recorded. The information processing apparatuses 1, 1a, 1b, and 1c may analyze viewer attributes based on a viewing history of web content such as a video streaming service.

The information processing apparatuses 1, 1a, 1b, and 1c may analyze user attributes, in addition to the viewer preferred genre, by extracting the program name and series name, channel, target user demographic, and segment name and the like of a program preferred by the viewer as the characteristics of the viewer. The information processing apparatuses 1, 1a, 1b, and 1c may select a searching service based on the analyzed preference, in which case, for example, the information processing apparatuses 1, 1a, 1b, and 1c may store this information as user information and select a searching service based on correspondence information that associates the viewer characteristics with the searching service.

The information processing apparatuses 1, 1a, 1b, and 1c may output the selected service information based on the viewing history of a viewer. The information processing apparatuses 1a, 1b, and 1c may, for example, if the preferred genre of the viewer is “Cooking”, regardless of the program being watched, provide a recipe search in a time slot before a meal at midday or in the early evening. In this manner, the information processing apparatuses 1a, 1b, and 1c may select a searching service in accordance with the viewing history of the viewer and the time slot or the like and judge whether or not to output selected service information based on the viewing history and time slot or the like.

The information processing apparatuses 1, 1a, 1b, and 1c may directly associate the viewing information of a viewer with a searching service. For example, if a specific program is associated with a searching service and a specific program is included in the viewing information, the corresponding searching service may be provided. In this manner, the viewing information and the searching service may be directly associated. The viewing information and the searching service may be indirectly associated, such as by associating attributes of a viewer estimated by analyzing the viewing information with a searching service.

The form of the correspondence information associating the viewing information, the viewer attributes, the searching service, and the priority need not be as described above. For example, the correspondence information may make a group association among viewing information, viewer attributes, and searching services. The correspondence information between the viewer attributes and the searching services and the correspondence information between the searching services and the priorities may be stored in separate storage devices. In this manner, the correspondence information may associate two or more information, including viewing information, viewer attributes, searching services, and priorities. Each of the associations may be stored either in the same storage device or in different storage devices.

The above-described devices may have the functions of other devices. For example, the terminal device 2 may have the function of the information processing apparatus 1 and may analyze the viewer attributes of its own user and provide a searching service. The information processing apparatuses 1, 1a, 1b, and 1c may have the functions of the program information providing apparatus 3, the viewing information server apparatus 4, the display template server apparatus 5, and the searching service providing apparatus 6. For example, the viewing information of the viewer may be transmitted directly from the terminal device 2 to the information processing apparatus 1, 1a, 1b, or 1c and stored therein. The information processing apparatus 1, 1a, 1b, and 1c may, when analyzing viewer attributes, acquire viewing information of the viewer-under-analysis from the viewing information server apparatus 4. A part of the functionality of the above-described devices may be provided in another device. For example, a part or all of the functions of the program information database storage unit 111, the viewing history database storage unit 112, the user information database storage unit 113, the searching service information database storage unit 114, and the operation history database storage unit 115 of the information processing apparatus 1, 1a, 1b, or 1c may be provided in an external device, with the information processing apparatuses 1, 1a, 1b, and 1c obtaining information from the external device, as necessary.

The information processing apparatuses 1, 1a, 1b, 1c and a part of the terminal device 2 in the above-described embodiments, for example the program information acquisition unit 13, the viewing information acquisition unit 14, the analysis unit 15, 15c, the selection unit 16, 16a, 16b, 16c, the judgment unit 17, 17b, 17c, the operation information acquisition unit 18, the keyword analysis unit 19, the genre analysis unit 151, the time slot analysis unit 152, the performer analysis unit 153, the target analysis unit 154, the viewing medium analysis unit 155, the user demographic analysis unit 156, the operation processing unit 251, the search information acquisition unit 252, the display template acquisition unit 253, and the display control unit 254, may be implemented by a computer, in which case, a program to implement those control functions is recorded in a computer-readable recording medium, and implementation is done by the program recorded in the recording medium being read into and executed by a computer.

The term “computer system” used here includes an OS (operating system) and hardware such as peripheral devices incorporated in the information processing apparatuses 1, 1a, 1b, and 1c and the terminal device 2. The term “computer-readable recording medium” refers to a removable medium such as a flexible disk, an optomagnetic disk, a ROM (read only memory), a CD-ROM, or the like, or to a storage device such as a hard disk or the like built into a computer system. Additionally, the term “computer-readable recording medium” encompasses one holding a program over a short time dynamically such as a communication line in the case in which a program is transmitted via a network such as the Internet or via a communication line such as a telephone line and one holding a program for a given period of time as a volatile memory within a computer system serving as a server or client. The above-noted program may be for implementing a part of the above-described functionality. Additionally, it may be one enabling implementation by combination with a program that already has recorded the above-noted functionality in a computer system.

A part or all of the information processing apparatuses 1, 1a, 1b, and 1c and the terminal device 2 in the above-described embodiments may be implemented by circuitry such as LSI (large-scale integration) or the like. The various functional blocks of the information processing apparatuses 1, 1a, 1b, and 1c and the terminal device 2 may be made as distinct processors, or a part or all of them may be integrated as a processor. Also, the method of circuit implementation is not limited to LSI, and implementation may be done with dedicated circuitry or a general-purpose processor. Additionally, in the event that, as a result of advances in semiconductor technology LSI is replaced by another circuit integration technology, that technology may be used to implement the circuitry.

Although the foregoing has been a detailed description of an embodiment of the present invention, with references made to the drawings, the specific constitution is not limited to that described above, and can be subject to various design modifications, within the scope of the spirit of the invention.

As used herein, the following directional terms “forward,” “rearward,” “above,” “downward,” “vertical,” “horizontal,” “below,” and “transverse,” as well as any other similar directional terms refer to those directions of an apparatus equipped with the present invention. Accordingly, these terms, as utilized to describe the present invention should be interpreted relative to an apparatus equipped with the present invention.

The term “configured” is used to describe a component, section or part of a device which includes hardware and/or software that is constructed and/or programmed to carry out the desired function.

The terms of degree such as “substantially,” “about,” and “approximately” as used herein mean a reasonable amount of deviation of the modified term such that the end result is not significantly changed. For example, these terms can be construed as including a deviation of at least ±5 percent of the modified term if this deviation would not negate the meaning of the word it modifies.

It is apparent that the present invention is not limited to the above embodiments, and may be modified and changed without departing from the scope and spirit of the invention.

What is claimed is:

1. An information processing method for an information processing apparatus, the information processing method comprising:
acquiring viewing information indicating a state of television broadcast viewed by a viewer;
acquiring from a storage unit included in the information processing apparatus, correspondence information indicating correspondence between a searching service that searches information in a prescribed field and the viewing information, and
selecting a searching service based on the correspondence information acquired and the viewing information acquired; and
outputting selected service information indicating the searching service selected.

2. The information processing method according to claim 1, wherein
the correspondence information includes a first correspondence information associating viewer attributes with the searching services and a second correspondence information associating the viewer attributes with the viewing information, and
the information processing method further comprises:
analyzing viewer attributes, based on the correspondence information acquired from the storage unit and the viewing information acquired, and
selecting the searching service, based on the correspondence information acquired from the storage unit and the viewer attributes analyzed.

3. The information processing method according to claim 2, wherein analyzing the viewer attributes comprises:
classifying the viewers into any one of a plurality of groups, based on the correspondence information acquired from the storage unit and the viewing information acquired.

4. The information processing method according to claim 2, wherein analyzing the viewer attributes comprises:
extracting a characteristic of the viewer, based on the correspondence information acquired from the storage unit and the viewing information acquired.

5. The information processing method according to claim 2, further comprising:
before outputting selected service information, judging whether or not to output the selected service information, based on the viewer attributes analyzed.

6. The information processing method according to claim 5, further comprising:
acquiring operation information indicating a utilization state of a searching service by the viewer,
wherein judging whether or not to output the selected service information comprises:
judging whether or not to output the selected service information, based on the operation information acquired.

7. The information processing method according to claim 2, wherein the correspondence information includes a third correspondence information associating the searching service and a priority of the searching service.

8. The information processing method according to claim 2, wherein analyzing the viewer attributes comprises:
estimating at least one of the age, gender, and lifestyle of the viewer, based on the correspondence information acquired from the storage unit and the viewing information acquired; and
based on the result of the estimating, analyzing a characteristic of the viewer by classifying the viewer into one of a plurality of groups.

9. The information processing method according to claim 2, wherein analyzing the viewer attributes comprises:
analyzing the viewer attributes by extracting a program genre preferred by the viewer as a characteristic of the viewer.

10. The information processing method according to claim 2, wherein
analyzing the viewer attributes comprises:
analyzing the viewer attributes by extracting a keyword related to a program preferred by the viewer as a characteristic of the viewer, and
the information processing method further comprises:
outputting the keyword extracted, as a search word candidate.

11. An information processing method for a terminal device configured to communicate with an information processing apparatus, comprising:
displaying a searching service indicated by selected service information output by the information processing apparatus, the searching service searching information in a prescribed field.

12. The information processing method according to claim 11, further comprising:
displaying a keyword output by the information processing apparatus as a search word candidate.

13. The information processing method according to claim 12, further comprising:
in accordance with the keyword output by the information processing apparatus, displaying a result of search processing executed by the searching service indicated by the selected service information output by the information processing apparatus.

14. An information processing system comprising:
an information processing apparatus; and
a terminal device, wherein
the information processing apparatus comprises:
a viewing information acquisition unit configured to acquire viewing information indicating the state of television broadcast viewed by a viewer;
a selection unit configured to
acquire from a storage unit, correspondence information indicating correspondence between a searching service that searches information in a prescribed field and the viewing information, and
select the searching service based on the acquired correspondence information and the viewing information acquired by the viewing information acquisition unit; and
an output unit configured to output selected service information indicating the searching service selected by the selection unit, and
the terminal device comprises:
a display unit; and
a display control unit configured to cause the display unit to display the searching service indicated by the selected service information output by the information processing apparatus.
